(19) United States
(12) Patent Application Publication
(10) Pub. No.: US 2007/0098920 A1
(43) Pub. Date: May 3, 2007

(54) Optical film, polarizing plate and liquid crystal display

(75) Inventors: Tsuyoshi Yamamoto, Odawara-shi (JP); Takeshi Senga, Tokyo (JP); Masaharu Kawai, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/528,285

(22) Filed: Sep. 28, 2006

(30) Foreign Application Priority Data
Sep. 30, 2005 (JP) 2005-288411

(51) Int. Cl. C09K 19/00; G02B 5/30

(52) U.S. Cl. 428/1.1; 428/1.31

(57) ABSTRACT

An optical film is provided and has a support and an optically anisotropic layer containing a fluorine-containing polymer and a liquid crystal compound. The relationship between the photoelectron takeoff angle φ(°) and the CFn intensity ratio P(%) obtained by AR-XPS measurement of the optically anisotropic layer gives P of 10% to 25% at φ of 20° and P of 15% to 20% at φ of 30°.

### BACKGROUND OF THE INVENTION

1. Field of the Invention

The present invention relates to an optical film and more particularly to an optical film having optical compensation capacity such that no unevenness occurs even in large-sized liquid crystal displays, and relates to a polarizing plate and a liquid crystal display comprising the same.

2. Description of Related Art

In recent years, optical films having a liquid crystal compound highly aligned and fixed have been developed for various purposes such as optically compensatory film and brightness enhancement film for liquid crystal display and optically compensatory film for projection type display device. In particular, the optically compensatory film for liquid crystal has made a remarkable technical progress.

A liquid crystal display comprises a polarizing plate and a liquid crystal cell.

In TFT liquid crystal displays of TN mode, which is the main stream in the art at present, an optically compensatory sheet is disposed interposed between the polarizing plate and the liquid crystal cell to attain a liquid crystal display having a high display quality. However, this method is disadvantageous in that the resulting liquid crystal display has a great thickness itself.

JP-A-2-247602 discloses that the use of an ellipsoidal polarizing plate having a retardation plate provided on one side of a polarizer and a protective film provided on the other side thereof makes it possible to enhance the front contrast without increasing the thickness of the liquid crystal display. However, in the retardation film (optically compensatory sheet) of the above document, a sufficient effect of enhancing viewing angle cannot be exerted, causing the deterioration of display quality of the liquid crystal display.

In accordance with the invention disclosed in JP-A-7-191217 and European Patent 0911656A2, when an optically compensatory sheet comprising an optically anisotropic layer formed by a discotic (disc-shaped) compound spread over a transparent support is used directly as a protective film for polarizing plate, viewing angle can be improved without increasing the thickness of the liquid crystal display.

In the related art technique, optically compensatory sheets have been developed focusing mainly on small-sized or middle-sized liquid crystal displays having a size of 15 inch or less. In recent years, however, it is necessary that large-sized liquid crystal displays having a size of 17 inch or more and a high brightness be focused.

It was found out that when a related art optically compensatory sheet is mounted on the polarizing plate for large-sized liquid crystal display as a protective film, unevenness occur on the panel. This defect doesn't become too outstanding with small-sized or middle-sized liquid crystal displays but easily becomes outstanding with the trend of higher size and higher brightness. It has thus been necessary that optical films that cope with unevenness in light leakage be developed.

JP-A-11-148080 discloses a technique which comprises incorporating a leveling agent in a polymerizable liquid crystal to eliminate unevenness. However, it was found out that this technique is effective only for the case where the polymerizable liquid crystal is homogeneously aligned and thus cannot be applied to complicated alignment such as hybrid alignment.

In addition to the aforementioned related art techniques, JP-A-2004-198511 discloses a method which comprises incorporating a polymer made of fluoroaliphatic group-containing monomer and (meth)acrylic monomer in the optically anisotropic layer to eliminate unevenness during display. This technique was recognized to have remarkable effects. However, the recent trend in market need seeks further rise of the size of display screen. Accordingly, in order to eliminate the occurrence of display unevenness, it has been desired to further eliminate unevenness, particularly streak unevenness in display screen.

### SUMMARY OF THE INVENTION

An object of an illustrative, non-limiting embodiment of the invention is to provide an optical film having an optically anisotropic layer excellent in image display quality, particularly a method for displaying a high quality image in large-sized liquid crystal displays without causing any unevenness, particularly drying unevenness or streak unevenness, on the surface of display and an optical film for use in this method.

Another object of an illustrative, non-limiting embodiment of the invention is to provide a polarizing plate with an optical compensation capacity having the aforementioned optical film and a liquid crystal display comprising the same.

The inventors made extensive studies on the basis of the techniques disclosed in the above cited JP-A-2004-198511 to find means of further eliminating display unevenness. As a result, it was found that when the formulation of the optically anisotropic layer is adjusted such that the angle dispersion of signal intensity in angle-resolved X-ray photoemission spectroscopy (hereinafter referred to as “AR-XPS”) of the surface of the optical anisotropic layer is controlled to a specific range, the viewability of the liquid crystal display can be remarkably improved. An exemplary embodiment of the invention has been worked out on the basis of this finding. In other words, the objects of the invention can be accomplished by the optical films and production method of Clauses (1) to (8) and the polarizing plate of Clause (9) and the liquid crystal display of Clause (10).

(1) An optical film including: a support; and an optically anisotropic layer containing a fluorine-containing polymer and a liquid crystal compound, wherein the relationship between the photoelectron takeoff angle φ (°) and the CFn intensity ratio P(%) obtained by AR-XPS measurement of the optically anisotropic layer gives P of 10% to 25% at φ of 20° and P of 15% to 20% at φ of 30°.

(2) The optical film as defined in Clause 1, wherein the fluorine-containing polymer is a copolymer.

(3) The optical film as defined in Clause 1 or 2, wherein the fluorine-containing polymer has a repeating unit derived from a hydrophilic monomer as a constituent monomer component.

(4) The optical film as defined in any one of Clauses 1 to 3, further comprising an alignment layer between the support and the optically anisotropic layer.

(5) The optical film as defined in any one of Clauses 1 to 4, wherein the optically anisotropic layer comprises a fluoroaliphatic group-containing copolymer containing a repeating unit derived from monomer (i) and a repeating unit derived from monomer (ii):

(i) Fluoroaliphatic group-containing monomer represented by formula (1); and

(ii) Poly(oxyalkylene)acrylate and/or poly (oxyalkylene)methacrylate: Formula (1) 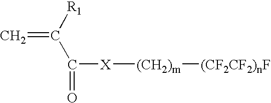
wherein R₁ represents a hydrogen atom or methyl group; X represents an oxygen atom, sulfur atom or —N(R₂)— (in which R₂ represents a hydrogen atom or C₁-C₄ alkyl group); m represents an integer of from 1 to 6; and n represents an integer of from 2 to 4.

(6) The optical film as defined in Clauses 1 to 5, wherein the optically anisotropic layer comprises a fluoroaliphatic group-containing copolymer containing a repeating unit derived from monomer (i), a repeating unit derived from monomer (ii) and a repeating unit derived from monomer (iii):

(i) Fluoroaliphatic group-containing monomer represented by formula (1) defined in Clause 5;

(ii) Poly(oxyalkylene)acrylate and/or poly (oxyalkylene)methacrylate; and

(iii) Monomer represented by formula (2) copolymerizable with the aforementioned monomers (i) and (ii): 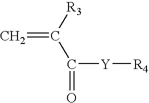
wherein R₃ represents a hydrogen atom or methyl group; Y represents a divalent connecting group; and R₄ represents a C₄-C₂₀ straight-chain, branched or cyclic alkyl group which may have substituents.

(7) The optical film as defined in any one of Clauses 1 to 6, wherein the liquid crystal compound is a discotic compound.

(8) A method for the production of an optical film defined in any one of Clauses 1 to 7, which comprises coating an optically anisotropic layer containing a fluorine-containing polymer and a liquid crystal compound on an alignment layer to form an optically anisotropic layer.

(9) A polarizing plate comprising an optical film defined in any one of Clauses 1 to 7.

(10) A liquid crystal display comprising an optical film defined in any one of Clauses 1 to 7.

### DETAILED DESCRIPTION OF THE EXEMPLARY EMBODIMENTS

Although the invention will be described below with reference to the exemplary embodiments thereof, the following exemplary embodiments and modifications do not restrict the invention.

According to an exemplary embodiment of the invention, by the control of the angle dispersion of signal intensity in AR-XPS of the surface of the optically compensatory layer to a specific range, it is possible to make effective optical compensation on liquid crystal cell and display a high quality image even in large-sized liquid crystal displays without causing unevenness, particularly drying unevenness or streak unevenness. Accordingly, a polarizing plate and a liquid crystal display which comprise this optical film and thus have no streak can be provided.

An optical film according to an exemplary embodiment of the invention is characterized by the use of photoelectron takeoff angle/CFn intensity ratio, by which unevenness can be suppressed to minimum as a means of suppressing unevenness paying attention to the fact that the angle dispersion dependence of radiant intensity in AR-XPS method attributed to fluorine-containing polymer contained in the optically anisotropic layer has effect on unevenness produced on the optically anisotropic layer, particularly drying unevenness or streak unevenness.

In some detail, the adjustment of the configuration of the optically anisotropic layer within an optimum range of the aforementioned photoelectron takeoff angle/CFn intensity ratio makes it possible to suppress unevenness, particularly drying unevenness or streak unevenness attributed to the optical film having an optically compensatory sheet and a polarizing plate in combination. Further, the application of this optical film to large-sized liquid crystal displays makes it possible to display a high display quality image without causing unevenness even with large area display.

An optical film according to an exemplary embodiment of the invention has an optically anisotropic layer containing a fluorine-containing polymer and a liquid crystal compound provided on a support. The relationship between the photoelectron takeoff angle φ(°) and the CFn intensity ratio P(%) obtained by AR-XPS measurement of the optically anisotropic layer gives P of 10% to 25% at φ of 20° and P of 15% to 20% at φ of 30°.

The relationship between the photoelectron takeoff angle φ(°) and the CFn intensity ratio P(%) more preferably gives P of 19% to 22% at φ of 20° and P of 15% to 17% at φ of 30°. The unevenness in the optical film shows unevenness also when the relationship deviates from the preferred range toward lower intensity side or higher intensity side.

The term “CFn peak intensity” as used herein is meant to indicate the peak intensity of emitted electron attributed to a fluorocarbon group: CFn (in which n represents the number of fluorine atoms) atomic group in the fluorine-containing polymer in the optically anisotropic layer.

The measurement conditions in AR-XPS method are as follows.
X-ray emitted: MG-Kα ray having 10 kV-10 mA is used;
Pass energy: 20 eV;
Step: 0.2 eV;
Dwell time: 0.1 s;
Integration: four times
Measurement angle: Angle φ of the surface of the sample with respect to the directional axis of the detector: 90°, 45°, 30°, 20°

The AR-XPS measurement apparatus is not specifically limited so far as it can analyze photoelectron spectrum from X-ray with varying angles. In an embodiment of the invention, a Type JPS-9000MX AR-XPS measurement apparatus (produced by JEOL) was used.

The optically anisotropic layer to be used in the invention will be further described first with reference to fluorine-containing polymer.

(Fluorine-Containing Polymer)

As the fluorine-containing polymer to be used in the invention there may be used any polymer which can be contained in the optically anisotropic layer and contains fluorine element as a constituent so far as it has a molecular weight falling within the above defined range and a composition ratio falling within the above defined range. In the invention, the aforementioned molecular weight can be determined by GPC (gel permeation chromatography). Referring to the measurement conditions, a 0.201% by mass THF solution of a fluorine-containing polymer is used. As the standard samples there are selected polystyrenes having a molecular weight of 1,090,000, 706,000, 427,000, 190,000, 96,400, 37,900, 800, 10,200, 5,970, 2,630, 1,050 and 500. A column of TSK gel is used. The content of fluorine-containing polymer is represented by the developed area ratio.

Preferred among the fluorine-containing polymers are copolymers having fluoroaliphatic group (hereinafter occasionally abbreviated as “fluorine-based polymer”). The fluorine-based polymer will be further described hereinafter.

Among the aforementioned fluorine-containing polymers, copolymers having a fluoroaliphatic group-containing structure and a poly(oxyalkylene)acrylate or methacrylate structure can remarkably exert the effect of the invention in particular. This fluoroaliphatic group-containing copolymer can have a monomer represented by formula (II) incorporated therein to properly adjust the optical properties of the optical film, making it possible to further enhance the effect of the invention or adjust the adaptability of the optical film to liquid crystal displays.

The fluorine-based polymer which is preferably used in the invention is preferably in the form of a copolymer with an acrylic resin or methacrylic resin satisfying the aforementioned requirement (1) or (2) or a vinyl-based monomer copolymerizable therewith to advantage.

One of the fluoroaliphatic groups in the fluorine-based polymer according to the invention is one derived from fluoroaliphatic compounds produced by telomerization method (referred to also as “telomer method”) or oligomerization method (referred to also as “oligomer method”). For the details of method for the production of these fluoroaliphatic group compounds, reference can be made to “Fusso Kagobutsu no Gosei to Kinou (Synthesis and Function of Fluorine Compounds)”, compiled by Nobuo Ishigawa, issued by CMC, 1987, pp. 117-118, and Milos Hudlicky and Attila E. Pavlath, “Chemistry of Organic Fluorine Compounds II”, Monograph 187, American Chemical Society, 1995, pp. 747-752. Telomerization method is a method which comprises subjecting a fluorine-containing vinyl compound such as tetrafluoroethylene to radical polymerization with an alkyl halide having a great chain transfer constant (e.g., iodide) as a telogen to synthesize a telomer (This method is exemplified in “Scheme-1”).

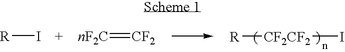

The iodine-terminated telomer thus obtained is normally chemically modified at the terminal thereof as shown in “Scheme-2” to form fluoroaliphatic compounds. These compounds are then optionally converted to desired monomer structures which are then used to produce fluoroaliphatic group-containing polymers.

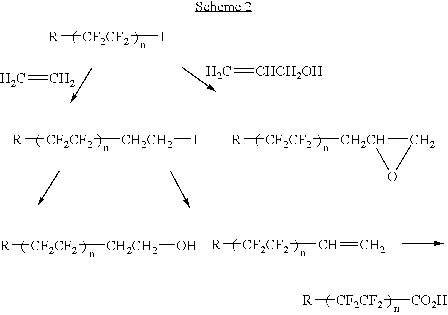

In formula (1), R₁ represents a hydrogen atom or methyl group and X represents an oxygen atom, sulfur atom or —N(R₂)—. R₂ represents a hydrogen atom or a C₁-C₄ alkyl group such as methyl, ethyl, propyl and butyl, preferably hydrogen atom or methyl group. X is preferably an oxygen atom.

In formula (1), m is an integer of from not smaller than 1 to not greater than 6, particularly preferably 2.

In formula (1), n is from 2 to 4, particularly preferably 2 or 3. Compounds having different n values may be used in admixture.

Specific examples of the fluoroaliphatic group-containing monomer represented by formula (1) will be given below, but the invention is limited thereto.

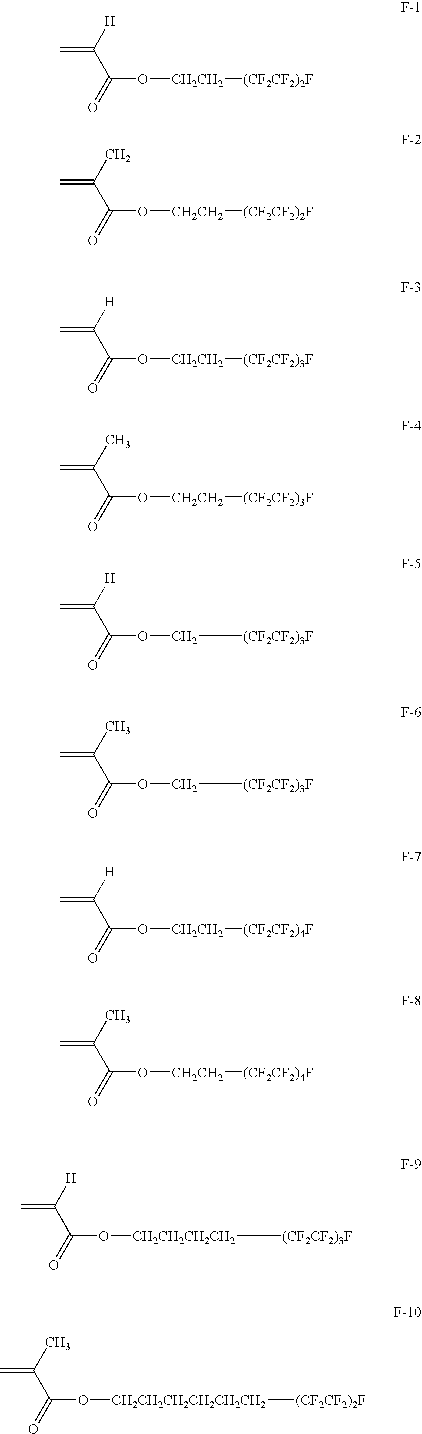

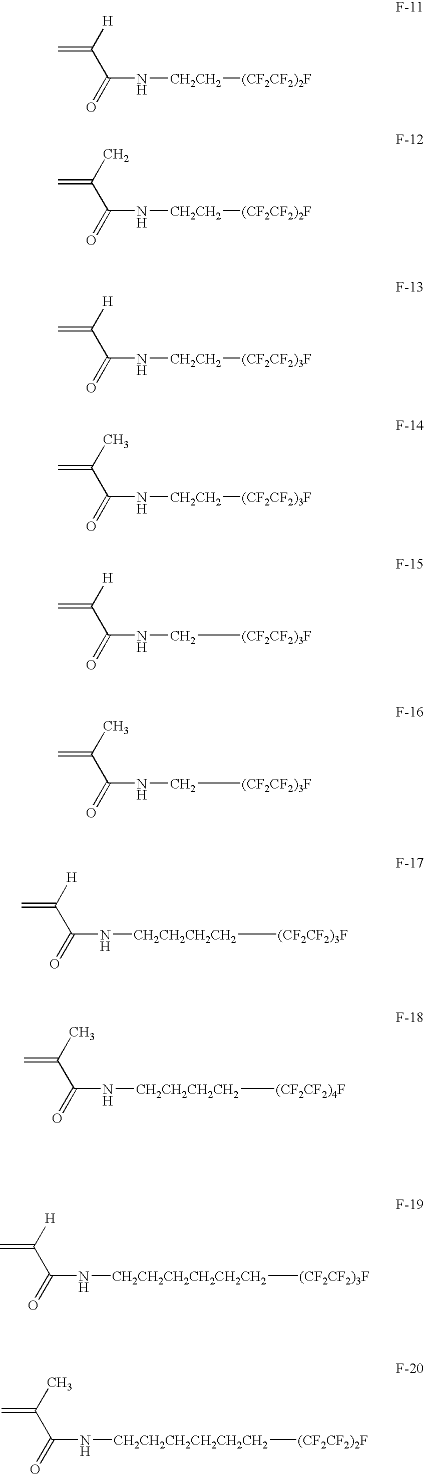

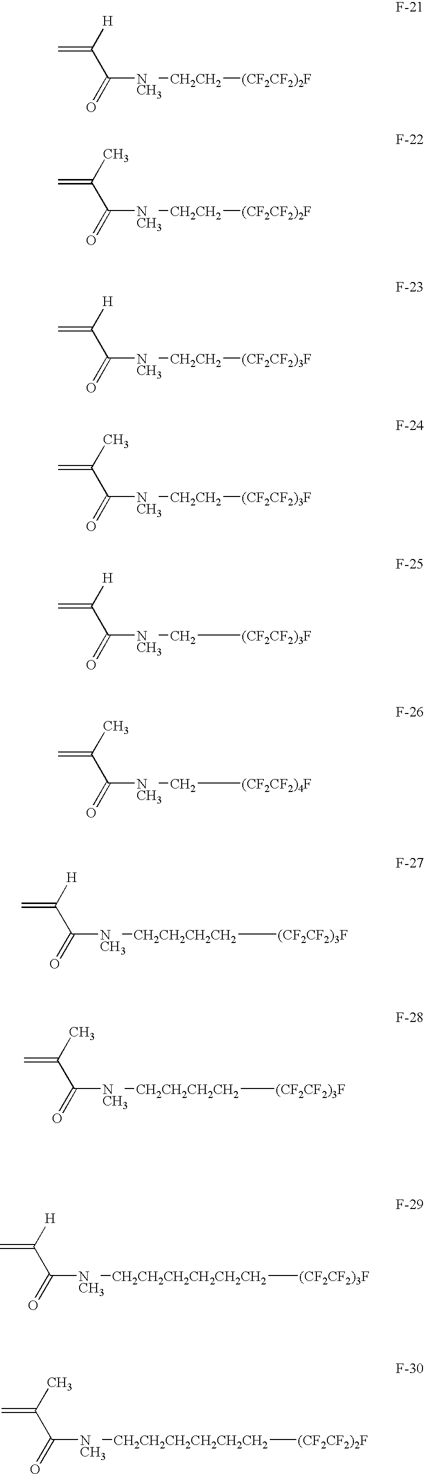

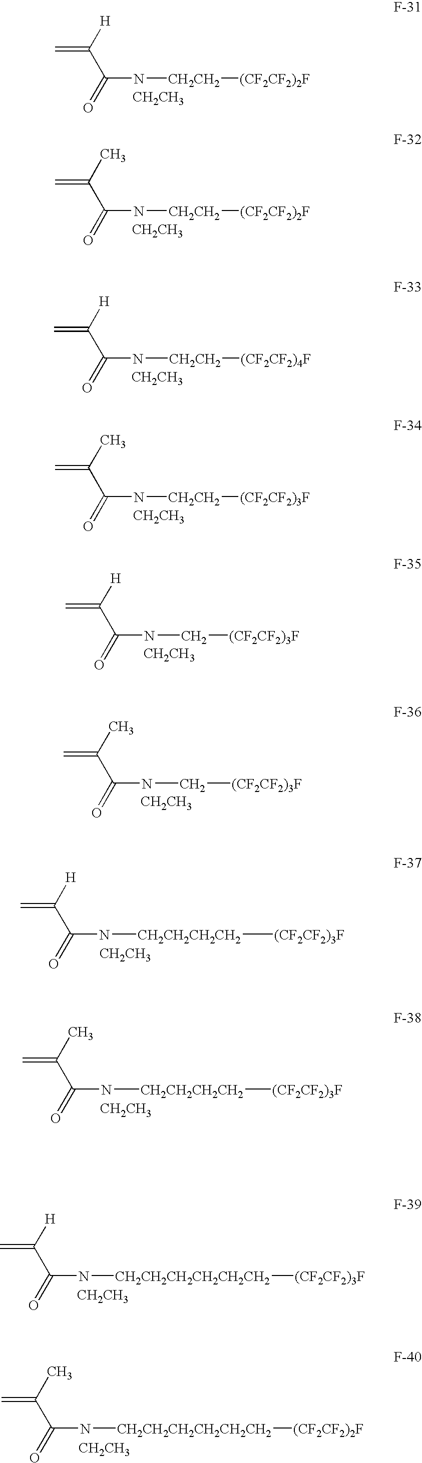

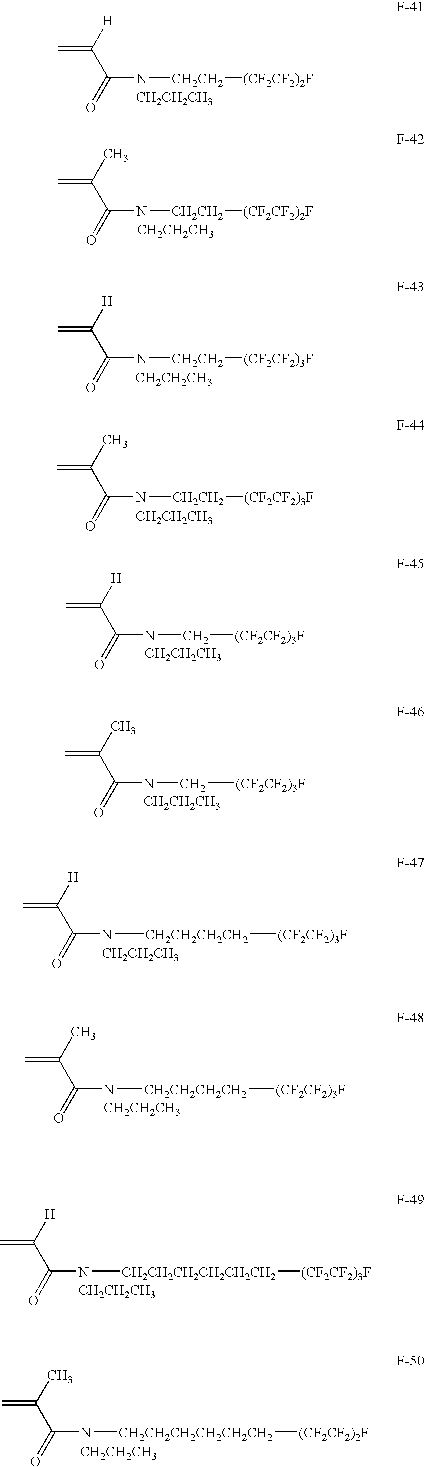

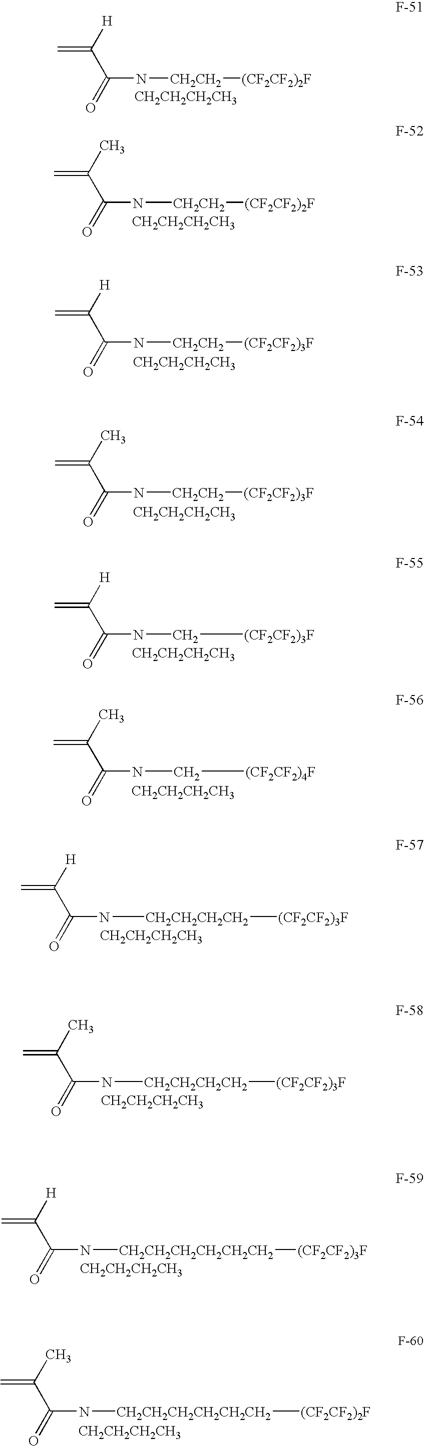

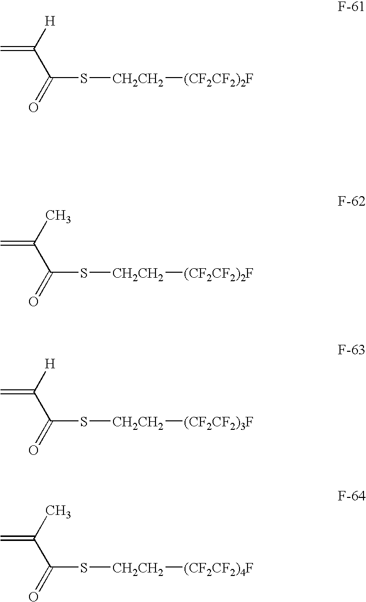

In formula (2), R₃ represents a hydrogen atom or methyl group and Y represents a divalent connecting group. The divalent connecting group is preferably an oxygen atom, sulfur atom or —N(R₅)— in which R₅ represents a hydrogen atom or a C₁-C₄ alkyl group such as methyl group, ethyl group, propyl group and butyl group. R⁵ is more preferably a hydrogen atom or methyl group.

Y is more preferably an oxygen atom, —N(H)— or —N(CH₃)—.

R₄ represents a straight-chain, branched or cyclic alkyl group having from not smaller than 4 to not greater than 20 carbon atoms which may have substituents. Examples of the substituents on the alkyl group of R⁴ include hydroxyl groups, alkylcarbonyl groups, arylcarbonyl groups, carboxyl groups, alkylether groups, arylether groups, halogen atoms such as fluorine, chlorine and bromine, nitro groups, cyano groups, and amino groups but the invention is not limited thereto. Preferred examples of the straight-chain, branched or cyclic alkyl group having from not smaller than 4 to not greater than 20 carbon atoms include butyl groups, pentyl groups, hexyl groups, heptyl groups, octyl groups, nonyl groups, decyl groups, undecyl groups, dodecyl groups, tridecyl groups, tetradecyl groups, pentadecyl groups, octadecyl groups, monocyclic cycloalkyl groups such as cyclohexyl group and cycloheptyl group, and polycyclic cycloalkyl groups such as bicycloheptyl group, bicyclodecyl group, tricycloundecyl group, tetracyclododecyl group, adamantyl group, norbornyl group and tetracyclodecyl group, which alkyl groups may be straight-chain or branched.

Specific examples of the monomer represented by the formula (2) will be given below, but the invention is not limited thereto.

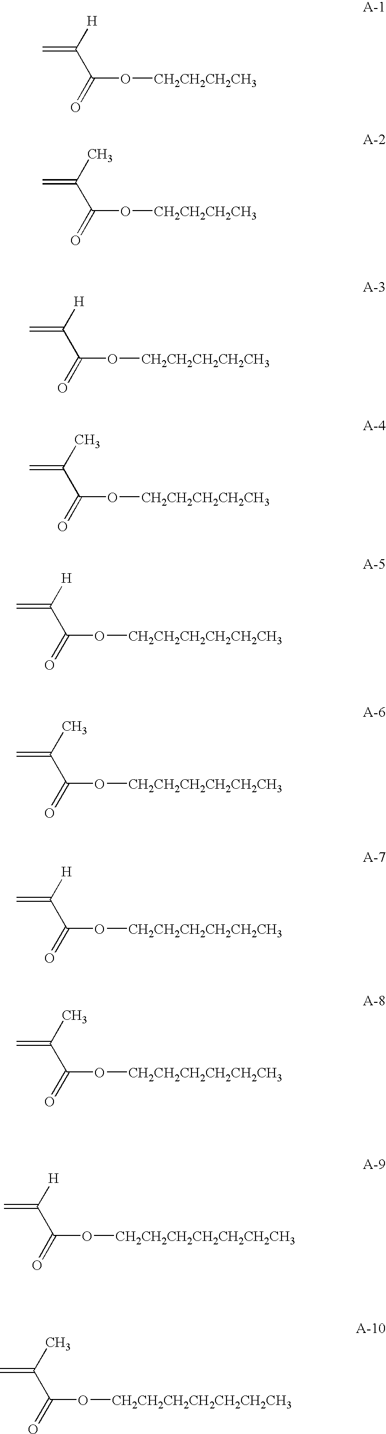

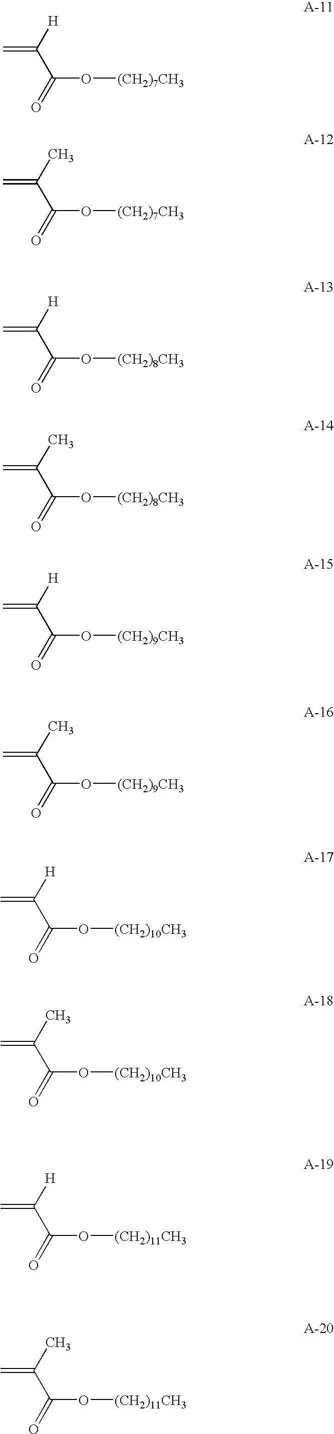

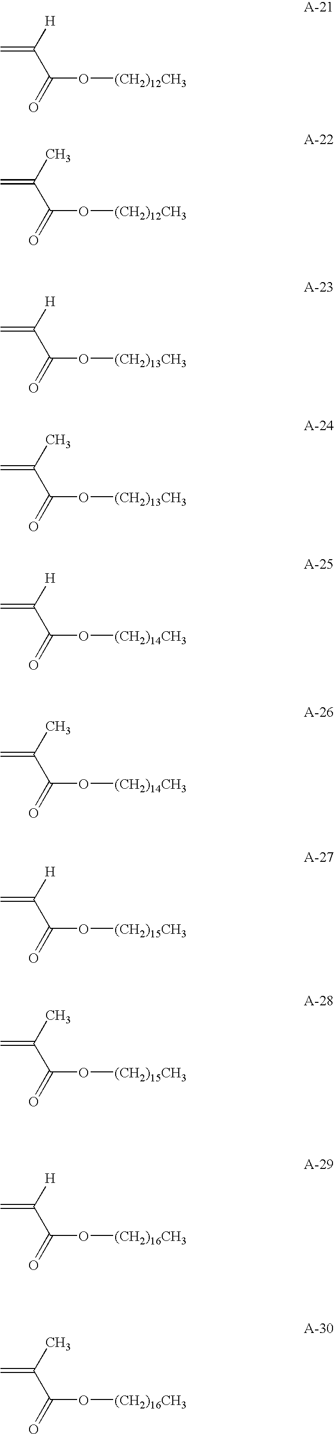

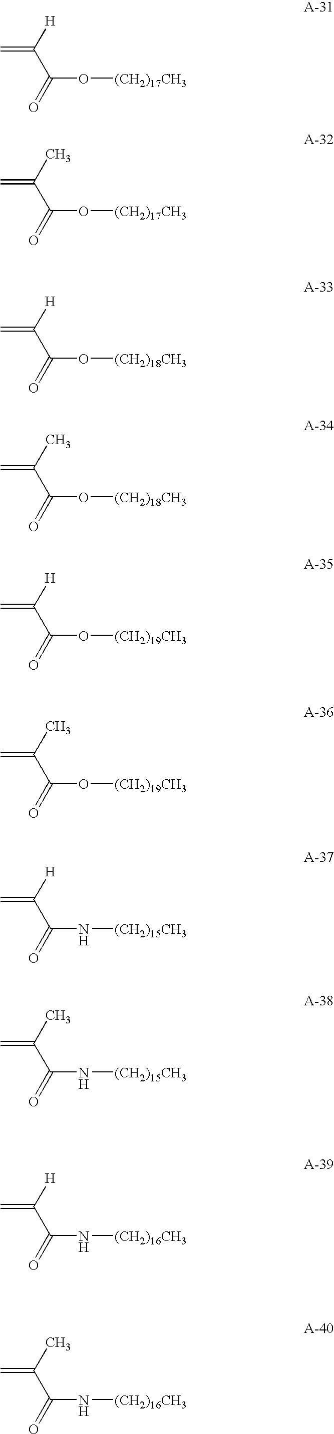

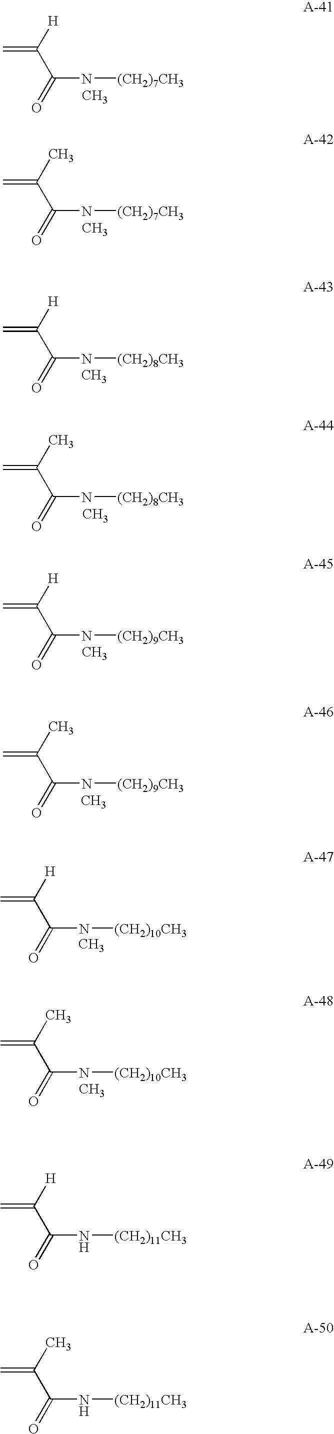

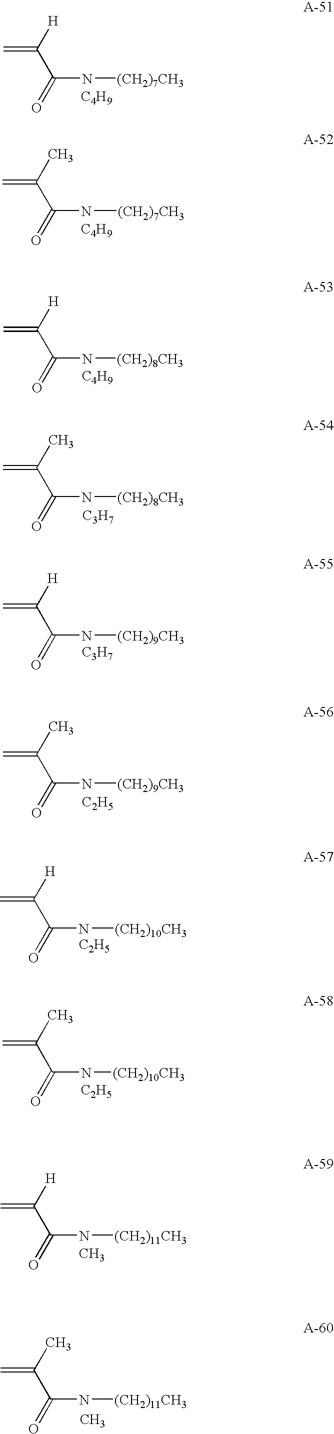

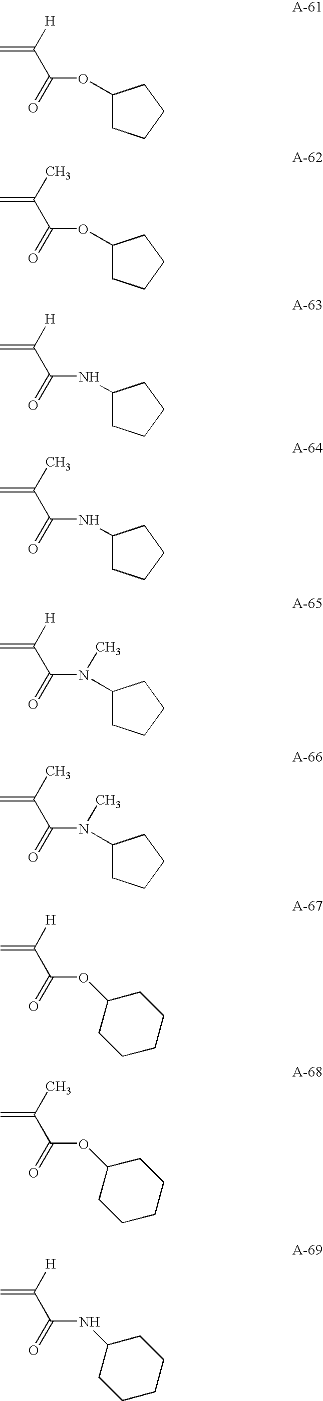

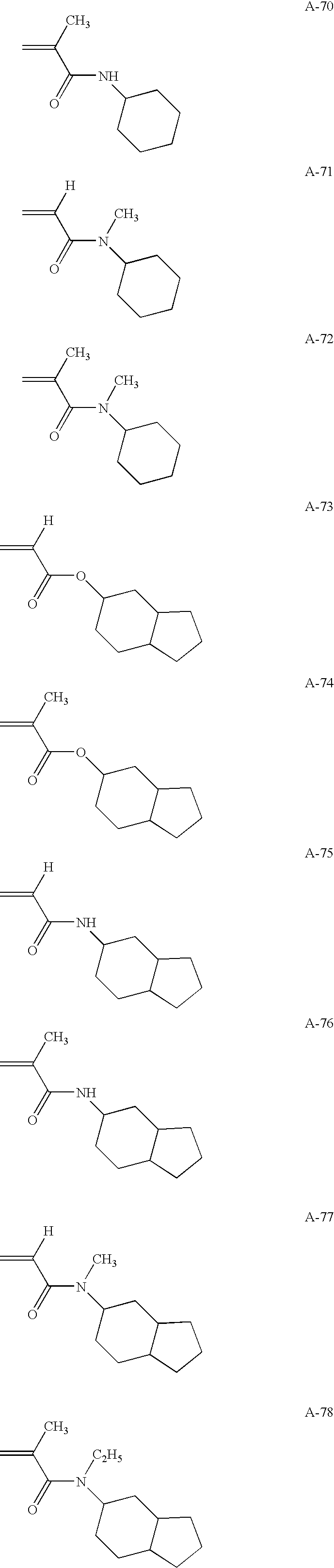

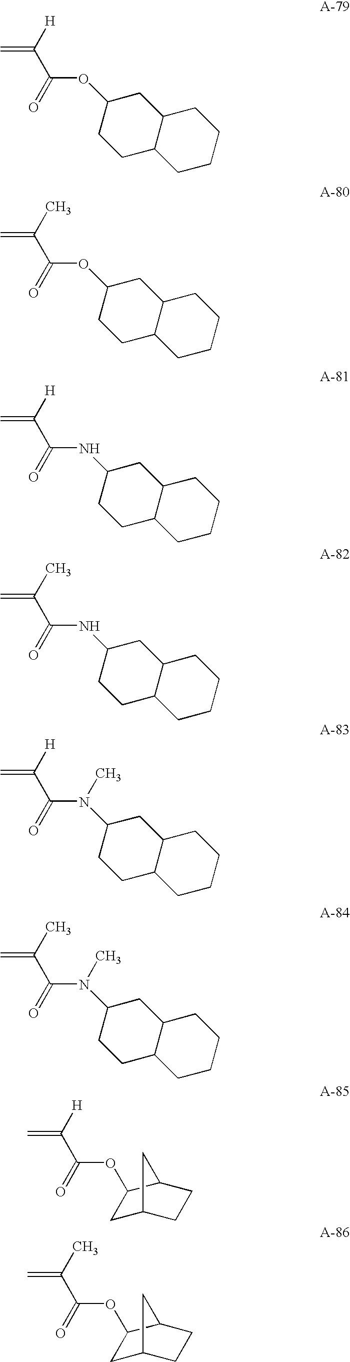

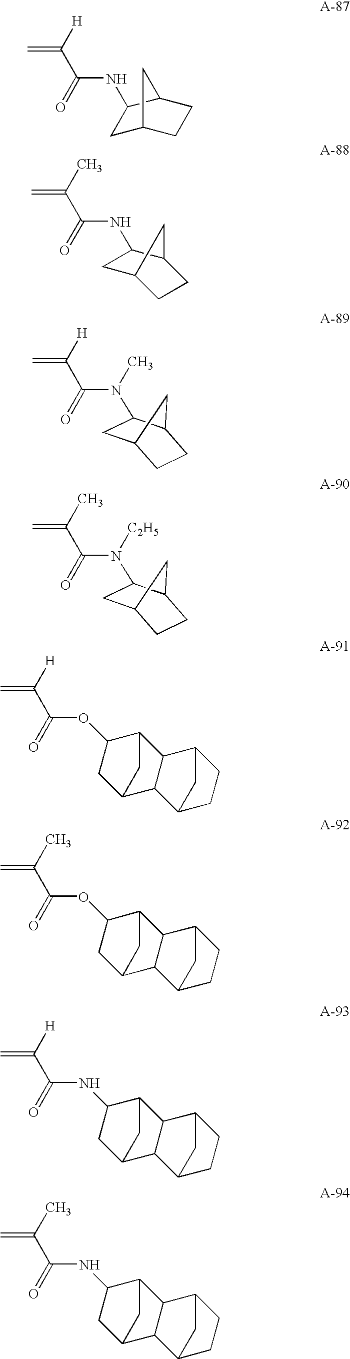

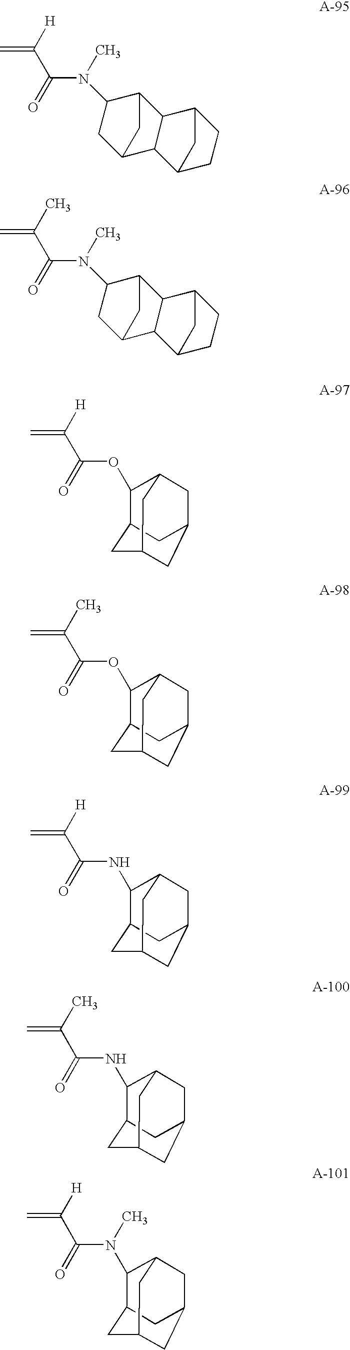

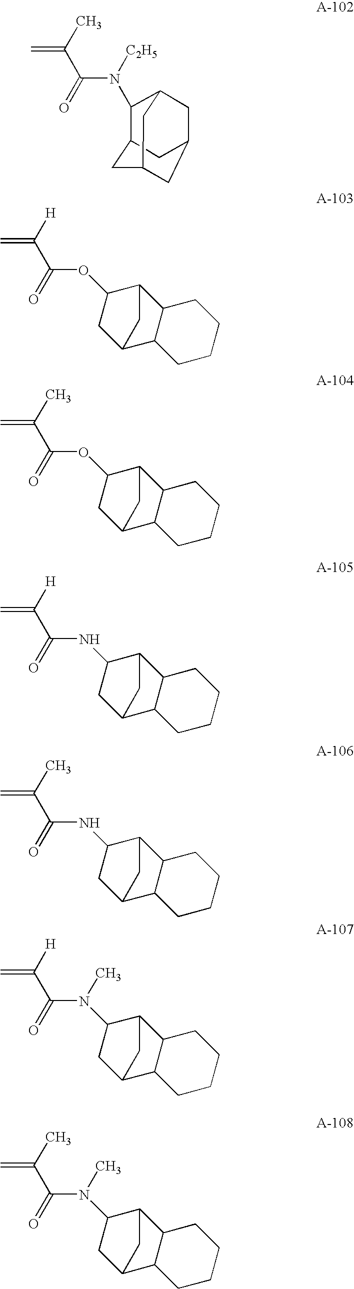

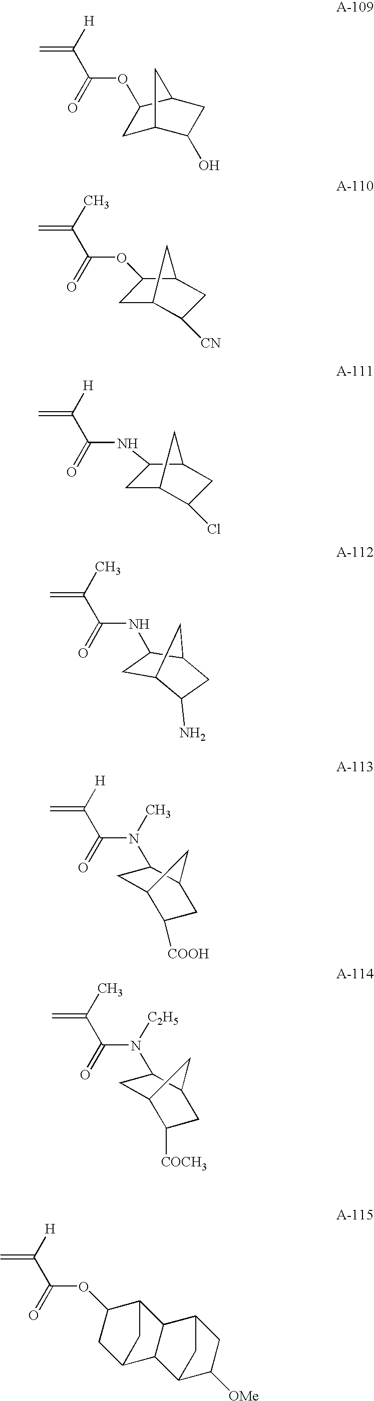

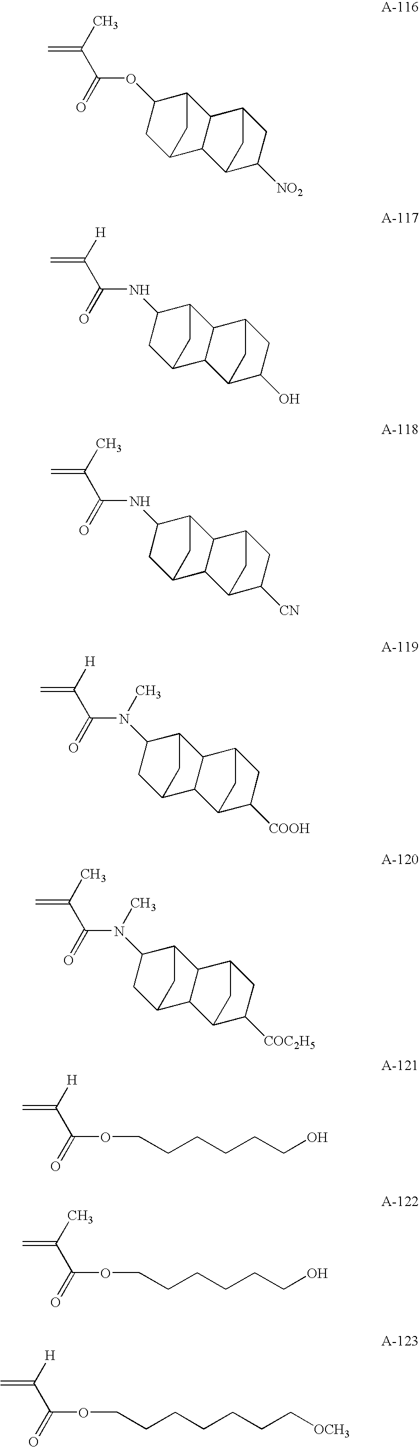

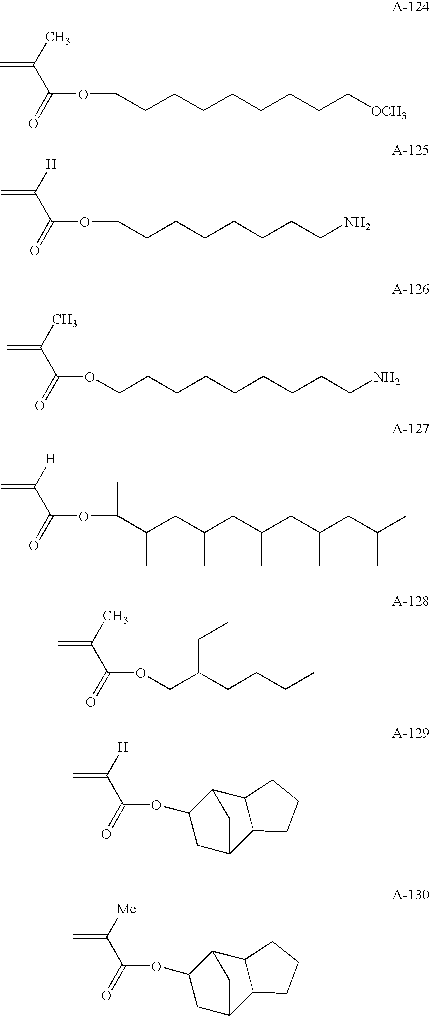

The poly(oxyalkylene)acrylate and/or poly (oxyalkylene)methacrylate (hereinafter occasionally referred collectively referred to as “(meth)acrylate” if both acrylate and methacrylate are intended) which is an essential component of the optically anisotropic layer constituting the optical film will be described hereinafter.

The polyoxyalkylene group can be represented by (OR)x in which R represents a C₂-C₄ alkylene group such as —CH₂CH₂—, —CH₂CH₂CH₂—, —CH(CH₃)CH₂— and —CH(CH₃)CH(CH₃)— and x represents the number of repetition of oxyalkylene groups, preferably from 2 to 30, more preferably from 3 to 25, most preferably from 4 to 20.

The oxyalkylene units in the poly(oxyalkylene) group may be the same as in the poly(oxypropylene) group. Alternatively, two or more different oxyalkylene units may be irregularly distributed. Alternatively, the oxyalkylene units may be straight-chain or branched oxypropylene units or oxyethylene units or may be present in the form of block of straight-chain or branched oxypropylene units or block of oxyethylene units.

This poly(oxyalkylene) chain may include a plurality of poly(oxyalkylene) units connected to each other with one or more chain binds (e.g., —CONH—Ph—NHCO—, —S— (in which pH represents a phenylene group)). In the case where the chain bond has a valence of three or more, it provides a means of obtaining a branched oxyalkylene unit. In the case where this copolymer is used in the invention, the molecular weight of the poly(oxyalkylene) group is preferably from 250 to 3,000.

The poly(oxyalkylene)acrylate and methacrylate can be produced by reacting a commercially available hydroxypoly(oxyalkylene) material such as “Pluronic” (produced by ADENKA CORPORATION, “Adekapolyether” (produced by ADENKA CORPORATION), “Carbowax” (produced by Glico Products), “Triton” (produced by Rohm and Haas) and “P.E.G” (produced by DAIICHI KOGYO CO., LTD.) with acrylic acid, methacrylic acid, acryl chloride, methacryl chloride, acrylic anhydride or the like by any known method.

Alternatively, poly(oxyalkylene)diacrylates produced by known methods may be used.

A copolymer of a monomer represented by formula (1) with a polyoxyalkylene (meth)acrylate, which is an essential component of the optically anisotropic layer, can be used. Polyoxyethylene (meth)acrylates are preferably included.

A particularly preferred embodiment is a polymer obtained by the copolymerization of three or more monomers, i.e., a monomer represented by formula (1), polyoxyethylene (meth)acrylate and polyoxyalkylene (meth)acrylate. The polyoxyalkylene (meth)acrylate is a monomer different from the polyoxyethylene (meth)acrylate.

More preferably, a terpolymer of a polyoxyethylene (meth)acrylate, a polyoxypropylene (meth)acrylate and a monomer represented by formula (1).

The copolymerization ratio of the polyoxyethylene (meth)acrylate is preferably from not smaller than 0.5 mol-% to not greater than 20 mol-%, more preferably from not smaller than 1 mol-% to not greater than 10 mol-% based on the total amount of the monomers.

The copolymer of a monomer represented by formula (1), a poly(oxyalkylene)acrylate and/or a poly(oxyalkylene)methacrylate and a monomer represented by formula (2) may be a copolymer obtained by the reaction of monomers copolymerizable with these monomers in addition to these monomers.

The copolymerization ratio of the copolymerizable monomers is preferably 20 mol-% or less, more preferably 10 mol-% or less based on the total amount of the monomers.

For the details of these employable monomers, reference can be made to “Polymer Handbook”, 2nd edition, J. Brandrup, Wiley Interscience, 1975, Chapter 2, pp. 1 to 483.

Examples of these monomers include compound having one addition-polymerizable unsaturated bond selected from the group consisting of acrylic acids, methacrylic acids, acrylic acid esters, methacrylic acid esters, acrylamides, methacrylamides, allyl compounds, vinylethers and vinylesters.

Specific examples of these monomers will be given below.
Acrylic acid esters:
Methyl acrylate, ethyl acrylate, propyl acrylate, chloroethyl acrylate, 2-hydroxyethyl acrylate, trimethylolpropane monoacrylate, benzyl acrylate, methoxybenzyl acrylate, furfuryl acrylate, tetrahydrofurfuryl acrylate, etc.
Methacrylic acid esters:
Methyl methacrylate, ethyl methacrylate, propyl methacrylate, chloroethyl methacrylate, 2-hydroxyethyl methacrylate, trimethylolpropane monomethacrylate, benzyl methacrylate, methoxybenzyl methacrylate, furfuryl methacrylate, tetrahydrofurfuryl methacrylate, etc.
Acrylamides:
Acrylamide, N-alkylacrylamide (The alkyl group is a C₁-C₃ alkyl group, e.g., methyl, ethyl, propyl), N,N-dialkyl acrylamide (The alkyl group is a C₁-C₃ alkyl group), N-hydroxyethyl-N-methyl acrylamide, N-2-acetamideethyl-N-acetyl acrylamide, etc.
Methacrylamides:
Methacrylamide, N-alkylmethacrylamide (The alkyl group is a C₁-C₃ alkyl group, e.g., methyl, ethyl, propyl), N,N-dialkyl methacrylamide (The alkyl group is a C₁-C₃ alkyl group), N-hydroxyethyl-N-methyl methacrylamide, N-2-acetamideethyl-N-acetyl methacrylamide, etc.
Allyl compounds:
Allylesters (e.g., allyl acetate, allyl caproate, allyl caprylate, allyl laurate, allyl palmitate, allyl stearate, allyl benzoate, allyl acetoacetate, allyl lactate), allyl oxyethanol, etc. Vinyl ethers:
Alkyl vinyl ether (e.g., hexyl vinyl ether, octyl vinyl ether, decyl vinyl ether, ethyl hexyl vinyl ether, methoxy ethyl vinyl ether, ethoxy ethyl vinyl ether, chloroethyl vinyl ether, 1-methyl-2,2-dimethylpropyl vinyl ether, 2-ethyl butyl vinyl ether, hydroxy ethyl vinyl ether, diethylene glycol vinyl ether, dimethylamioethyl vinyl ether, diethylaminoethyl vinyl ether, butylaminoethyl vinyl ether, benzyl vinyl ether, tetrahydrofurfuryl vinyl ether, etc.
Vinyl esters:
Vinyl butyrate, vinyl isobutyrate, vinyl trimethyl acetate, vinyl diethyl acetate, vinyl valate, vinyl caproate, vinyl chloroacetate, vinyl dichloroacetate, vinyl methoxyacetate, vinyl butoxyacetate, vinyl lactate, vinyl-β-phenyl butyrate, vinyl cyclohexyl carboxylate, etc.
Itaconic acid dialkyls:
Dimethyl itaconate, diethyl itaconate, dibutyl itaconate, etc.
Fumaric acid dialkylesters or monoalkylesters:
Dibutyl fumarate, etc.
Others: Crotonic acid, itaconic acid, acrylonitrile, methacrylonitrile, maleilonitrile, styrene, etc.

Some of fluorine-based chemical products produced by electrolytic fluorination method, which has heretofore been preferably used, are materials having a low biodegradability and a high bioaccumulatability and thus can exhibit reproduction toxicity or growth toxicity, though slight. The fluorine-based polymer according to an exemplary embodiment of the invention is industrially advantageous also in that it is a material having a higher environmental safety.

The amount of the fluoroaliphatic group-containing monomer represented by formula (1) in the fluorine-based polymer to be used in the invention is 5 mol-% or more, preferably from 5 to 70 mol-%, more preferably from 7 to 60 mol-% based on the total amount of the monomers constituting the polymer.

The amount of the poly(oxyalkylene)acrylate and/or poly(oxyalkylene)methacrylate which is an essential component in the fluorine-based polymer is 10 mol-% or more, preferably from 15 to 70 mol-%, more preferably from 20 to 60 mol-% based on the total amount of the monomers constituting the fluorine-based polymer.

The amount of the monomer represented by formula (2), which is preferably used in the fluorine-based polymer of the invention, is 3 mol-% or more, preferably from 5 to 50 mol-%, more preferably from 10 to 40 mol-% based on the total amount of the monomers constituting the fluorine-based polymer.

The weight-average molecular weight of the fluorine-based polymer to be used in the invention is preferably from 3,000 to 100,000, more preferably from 6,000 to 80,000.

The content of the fluorine-based polymer according to the invention based on the coating composition (coating components except solvent) mainly composed of liquid crystal compound is preferably from 0.005% to 8% by mass (weight), more preferably from 0.01% to 1% by mass, even more preferably from 0.05% to 0.5% by mass. When the added amount of the fluorine-based polymer falls below 0.005% by mass, the resulting effect is insufficient. On the other hand, when the added amount of the fluorine-based polymer exceeds 8% by mass, the coat film cannot be sufficiently effected or the properties of the optical film (e.g., uniformity in retardation) are adversely affected.

These fluorine-based polymers have a molecular weight distribution similarly to ordinary polymer compounds. In general, it is said that a polymer having a sharp molecular weight distribution, i.e., so-called monodisperse polymer is desirable. However, in the invention, an optical film having less unevenness or streak unevenness was realized by incorporating a fluorine polymer component having a weight-average molecular weight of 100,000 or more in a fluorine-containing polymer having a weight-average molecular weight of from 3,000 to 100,000 in an amount of 8% or more or by reducing the content of fluorine polymer components having a weight-average molecular weight of 20,000 or less to 61% or less or by effecting both.

The adjustment of molecular components such a polymer component and low molecular component was made by molecular weight cut-off using GPC.

The fluorine-based polymer to be used in the invention can be produced by any known conventional method such as method which comprises adding a general-purpose radical polymerization initiator to an organic solvent containing the aforementioned monomers such as (meth)acrylate having a fluoroaliphatic group or polyoxyalkylene group so that they are polymerized. In some cases, the aforementioned radical polymerization can be effected with other addition-polymerizable unsaturated compounds added. Dropwise polymerization which comprises polymerization with monomers and initiator added dropwise to the reaction vessel depending on the polymerizability of the various monomers is also effective to obtain a polymer having a uniform composition.

Specific examples of the structure of the fluorine-based polymer to be used in the invention will be given below, but the invention is not limited thereto. The figure in the following formulae each indicate the percent molar ratio of the monomer components. Mw indicates the weight-average molecular weight. 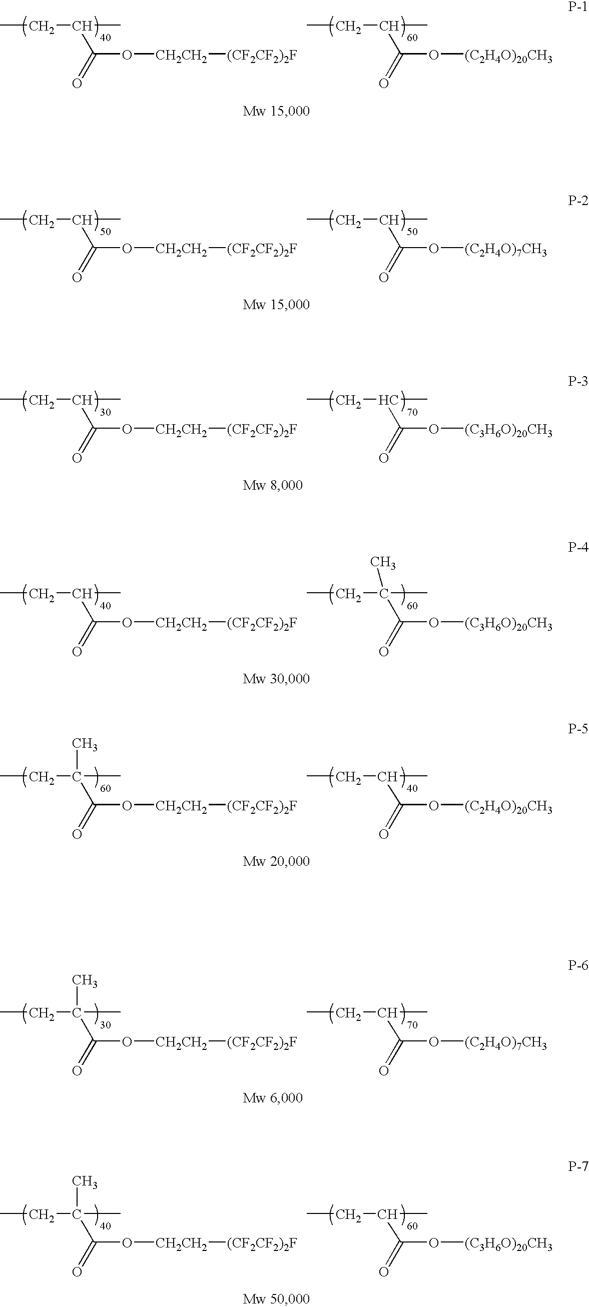 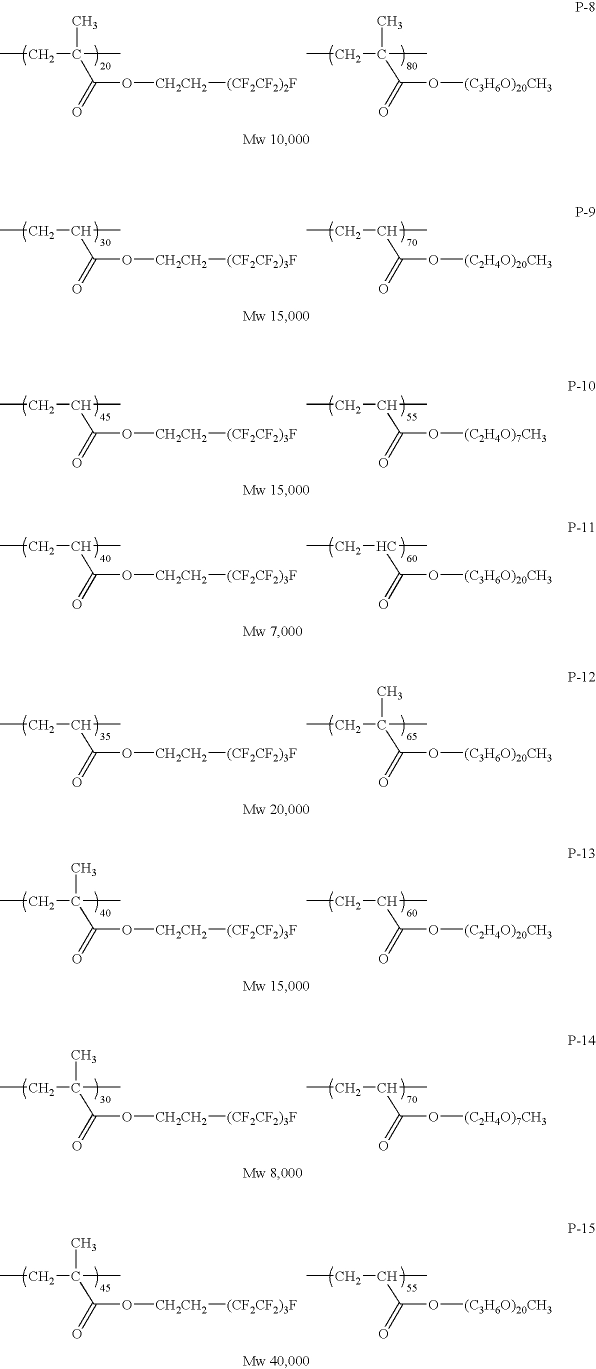 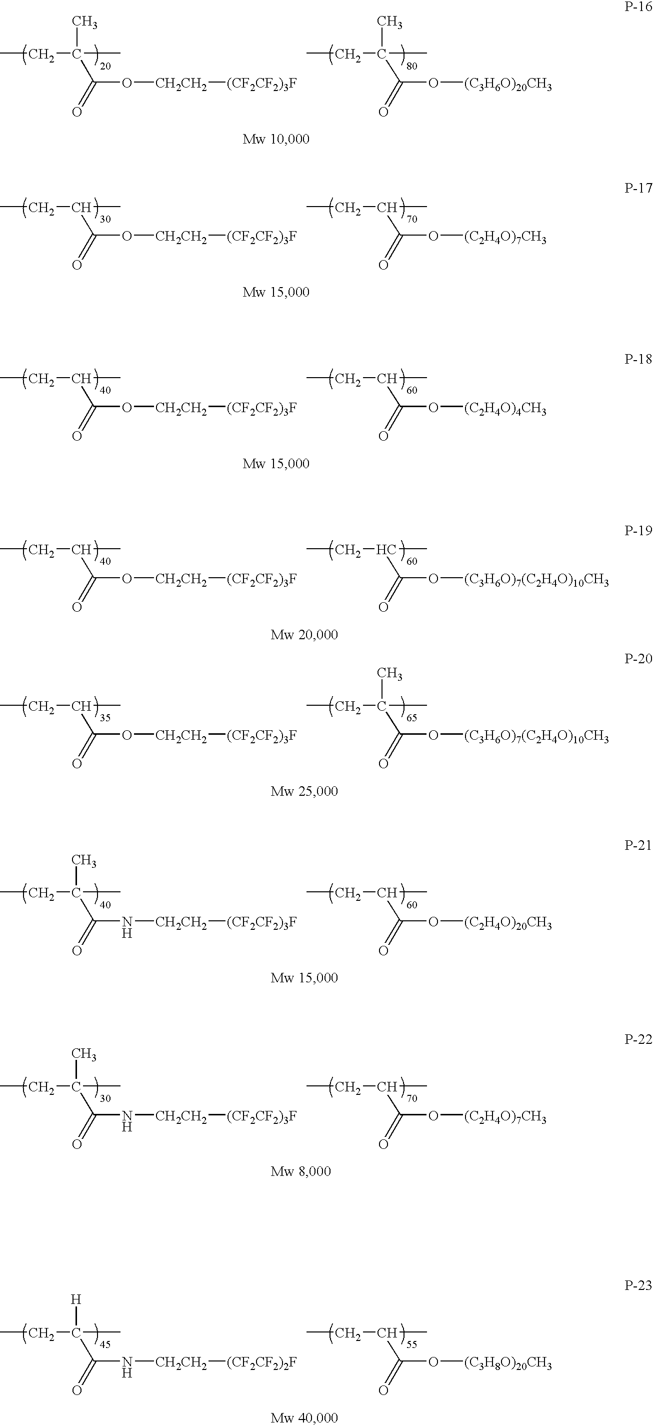 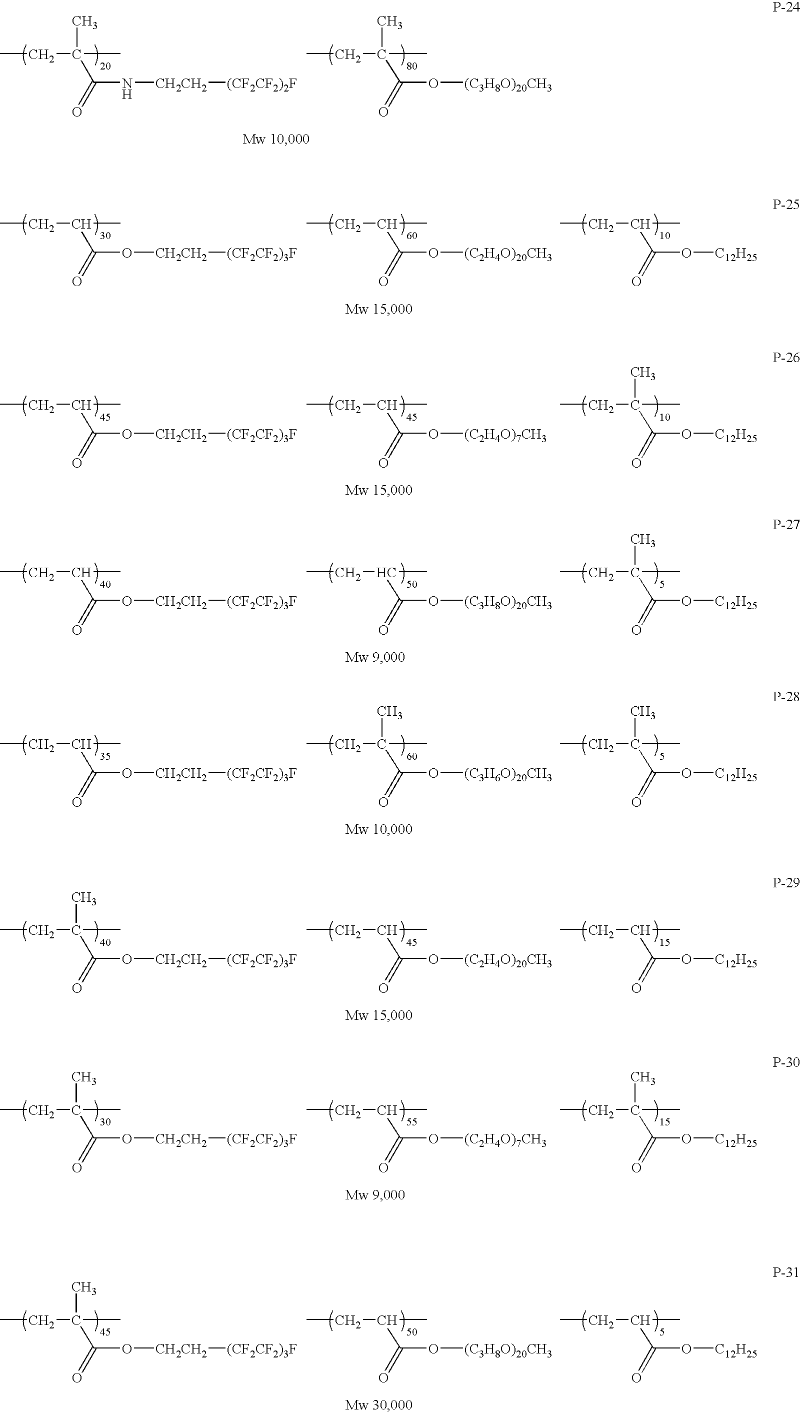 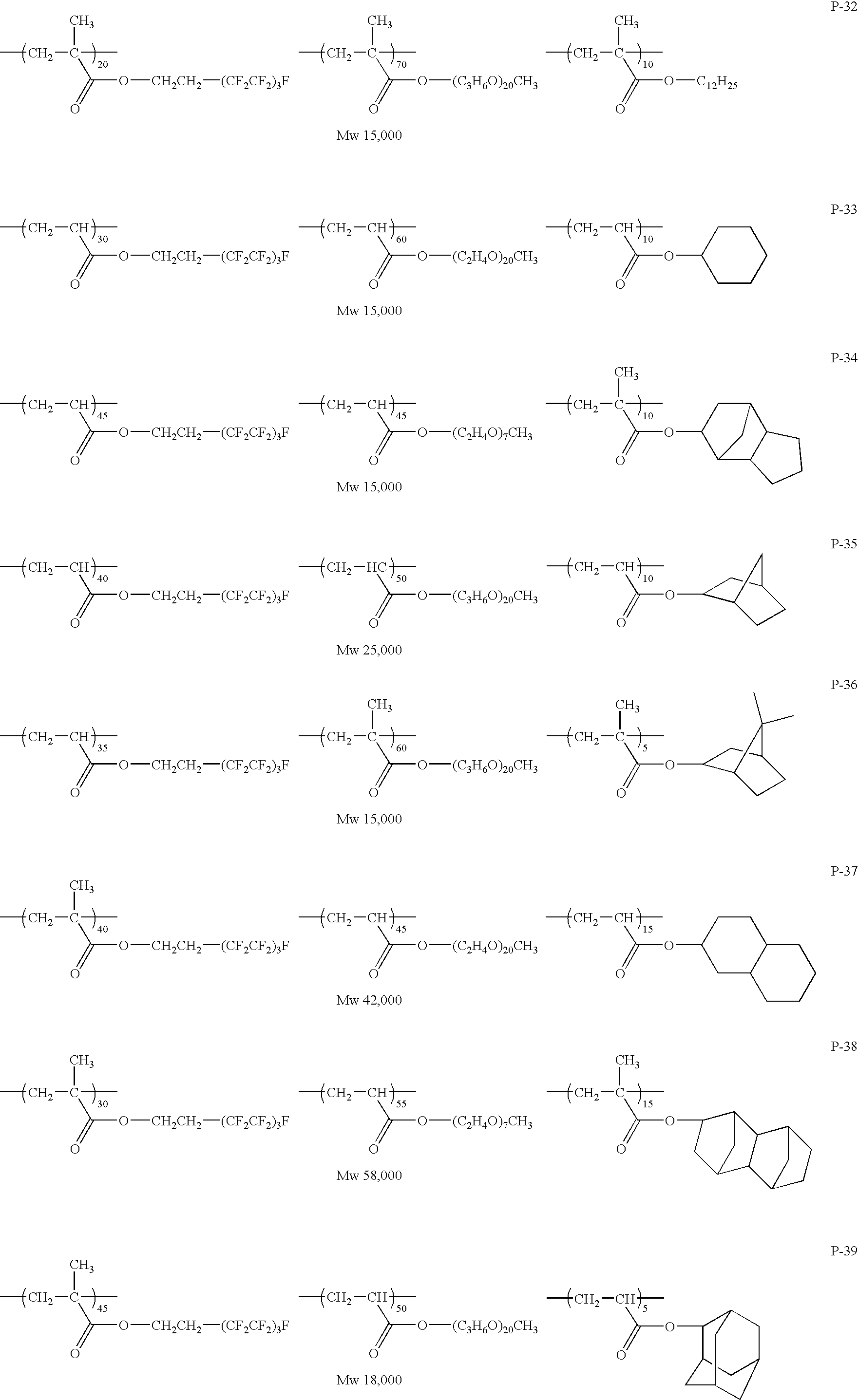 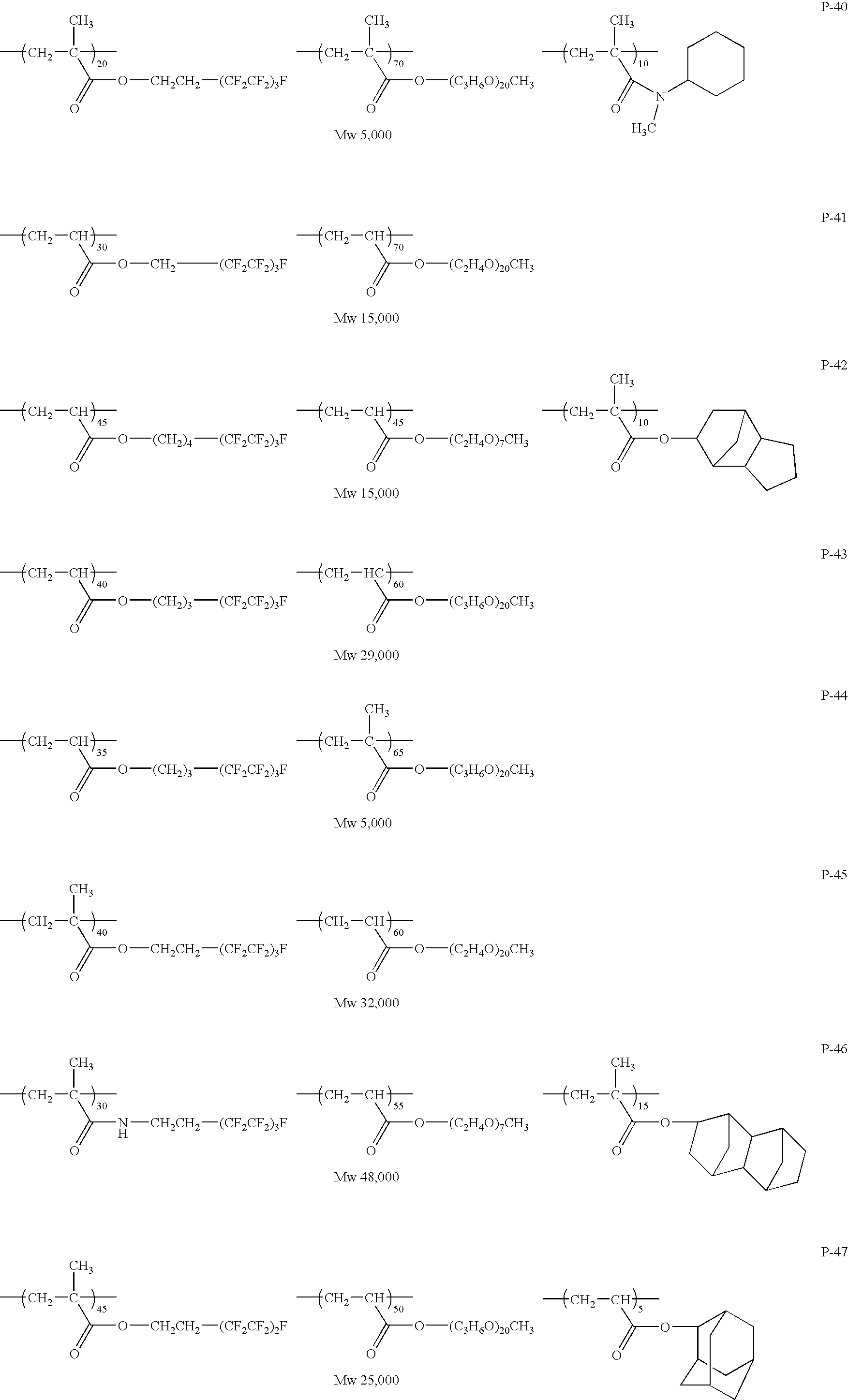 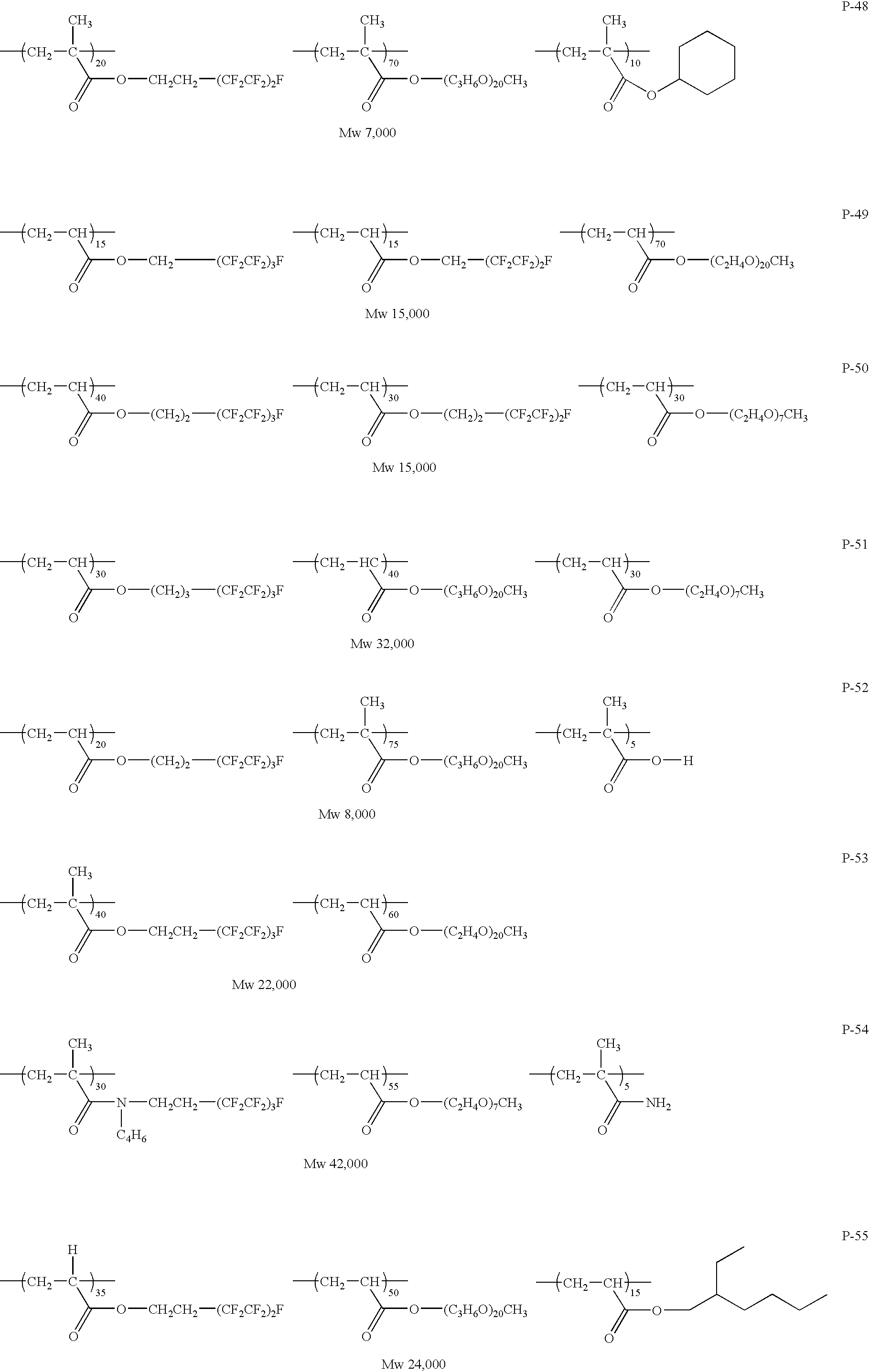 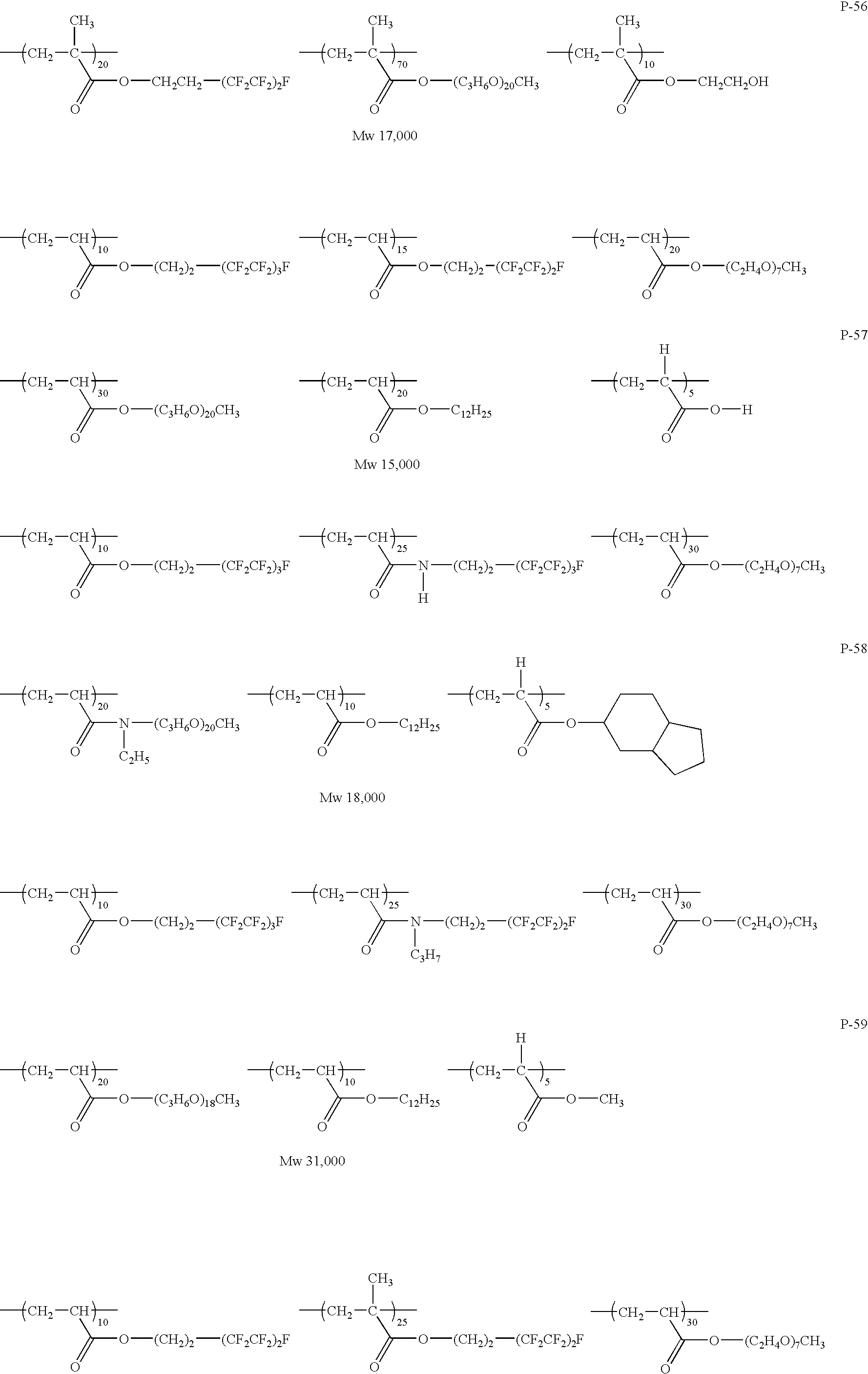 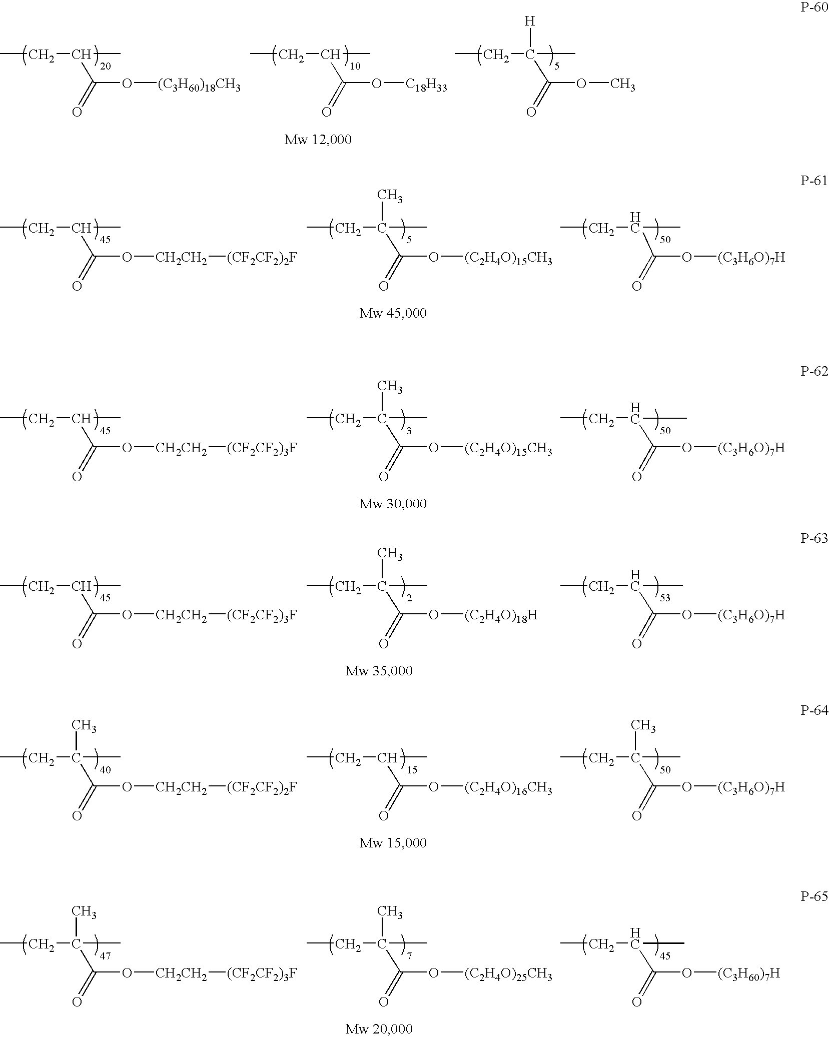
(Optically Anisotropic Layer)

In the invention, the fluorine-based polymer contained in the optically anisotropic layer has been already described. The other configurations of the optically anisotropic layer and the method for forming the optically anisotropic layer will be described hereinafter.

The optically anisotropic layer is preferably designed to compensate the liquid crystal compound in the liquid crystal cell when the liquid crystal display makes black display. The state of alignment of the liquid crystal compound in the liquid crystal cell during black display differs with the mode of the liquid crystal display. For the details of state of alignment of liquid crystal compound in liquid crystal cell, reference can be made to IDW'00, FMC7-2, pp. 411-414.

The optically anisotropic layer optical film is formed from liquid crystal molecules on the support directly or with an alignment film interposed therebetween. The alignment film preferably has a thickness of 10 μm or less.

Examples of the liquid crystal molecules to be incorporated in the optically anisotropic layer include rod-shaped liquid crystal molecules and discotic compounds. The rod-shaped liquid crystal molecules and the discotic compounds may be polymer liquid crystals or low molecular liquid crystals. Those which have been obtained by crosslinking low molecular liquid crystals and thus show no longer liquid crystal properties are included.

The optically anisotropic layer can be formed by coating a coating solution (composition) containing liquid crystal molecules and optionally a polymerization initiator or arbitrary components over the alignment film.

For preferred examples of the alignment film of the invention, reference can be made to JP-A-8-338913.

As the solvent to be used in the preparation of the coating solution there is preferably used an organic solvent. Examples of the organic solvent employable herein include amides (e.g., N,N-dimethylformamide), sulfoxides (e.g., dimethyl sulfoxide), heterocyclic compounds (e.g., pyridine), hydrocarbons (e.g., benzene, hexane), alkyl halides (e.g., chloroform, dichloromethane, tetrachloroethane), esters (e.g., methyl acetate, butyl acetate), ketones (e.g., acetone, methyl ethyl ketone), and ethers (e.g., tetrahydrofurane, 1,2-diemthoxyethane). Preferred among these organic solvents are alkyl halides and ketones. Two or more of these organic solvents may be used in combination.

In the case where an optical film having a very high uniformity is produced as in the invention, the surface tension of the coating solution is preferably 25 mN/m or less, more preferably 22 mN/m or less.

The spreading of the coating solution can be carried out by any known method (e.g., wire bar coating method, extrusion coating method, direct gravure coating method, reverse gravure coating method, die coating method).

The thickness of the optically anisotropic layer is preferably from 0.1 μm 20 μm, more preferably from 0.5 μm to 15 μm, most preferably from 1 μm to 10 μm.

(Rod-Shaped Liquid Crystal Molecule)

Preferred examples of the rod-shaped liquid crystal molecules employable herein include azomethines, azoxys, cyanobiphenyls, cyanophenylesters, benzoic acid esters, cyclohexanecarboxylic acid phenylesters, cyanophenyl cyclohexanes, cyano-substituted phenylpyrimidines, alkoxy-substituted phenylpyrimidines, phenyldioxanes, tolans, and alkenylcyclohexylbenzonitriles.

The rod-shaped liquid crystal molecules also include metal complexes. Further, liquid crystal polymers containing rod-shaped liquid crystal molecules in its repeating units may be used as rod-shaped liquid crystal molecules. In other words, the rod-shaped liquid crystal molecules may be bonded to (liquid crystal) polymer.

For the details of rod-shaped liquid crystal molecules, reference can be made to “Quarterly Review of Chemistry”, The Chemical Society of Japan, No. 22, “Ekisho no Kagaku (Chemistry of Liquid Crystals)” (1994), Chapters 4, 7 and 11, and “Ekisho Debaisu Handobukku (Handbook of Liquid Crystal Devices)”, compiled by 142nd Committee, Japan Society for the Promotion of Science, Chapter 3.

The birefringence of the rod-shaped liquid crystal molecules is preferably from 0.001 to 0.7.

The rod-shaped liquid crystal molecules preferably have polymerizable groups to fix its alignment. These polymerizable groups are preferably unsaturated polymerizable groups or epoxy groups, more preferably unsaturated polymerizable groups, most preferably ethylenically unsaturated polymerizable groups.

(Discotic Compound)

Examples of the discotic liquid crystal compound employable herein include benzene derivatives disclosed in C. Destrade et al's study report “Mol. Crysr. Liq. Cryst.”, vol. 71, page 111, 1981, truxene derivatives disclosed in C. Destrade et al's study report “Mol. Crysr. Liq. Cryst.”, vol. 122, page 141, 1985, and “Physics Lett”, A, vol. 78, page 82, 1990, cyclohexane derivatives disclosed in the study report of B. Kohne et al. (“Angew. Chem.”, vol. 96, page 70, 1984), and azacrown-based and phenylacetylene-based macrocycles disclosed in J. M. Lehn et al's study report “J. Chem. Commun.”, page 1794, 1985 and J. Zhang et al's study report “J. Am. Chem. Soc.”, vol. 116, page 2,655, 1994.

Examples of the aforementioned discotic liquid crystal compounds include liquid crystal compounds comprising a nucleus disposed at the center of the molecule and straight-chain alkyl groups, alkoxy groups or substituted benzoyloxy groups disposed radially on the nucleus as side chains of the nucleus. The discotic liquid crystal compound is preferably a compound the molecules or molecule aggregate of which have a rotary symmetry and thus can be aligned as desired. The optically anisotropic layer, if formed by discotic liquid crystal molecules, the compound which is finally incorporated in the optically anisotropic layer no longer needs to be discotic liquid crystal molecules. For example, in the case where the low molecular discotic liquid crystal compound has a group which reacts when heated or irradiated with light so that when heated or irradiated with light, the resulting reaction of the group causes the low molecular discotic liquid crystal compound to undergo polymerization or crosslinking to form an optically anisotropic layer, the compound incorporated in the optically anisotropic layer may no longer maintain its liquid crystal properties. For the preferred examples of the discotic liquid crystal compounds, reference can be made to JP-A-8-50206. For the details of polymerization of discotic liquid crystal compound, reference can be made to JP-A-8-27284.

In order to fix the discotic liquid crystal compound by polymerization, it is necessary that polymerizable groups be connected to the discotic core of the discotic liquid crystal compound as substituents. However, when polymerizable groups are directly connected to the discotic core, it is difficult to keep the discotic liquid crystal molecules aligned as desired in the polymerization reaction. It is therefore necessary that connecting groups be incorporated in between the discotic core and the polymerizable groups. Accordingly, the discotic compound having polymerizable groups are those represented by formula (III).
D(−LQ)n (III)
wherein D represents a discotic core; L represents a divalent connecting group; Q represents a polymerizable group; and n represents an integer of from 4 to 12.

Examples of the discotic core (D) will be given below. In the following examples, LQ (or QL) means the combination of a divalent connecting group (L) and a polymerizable group (Q).

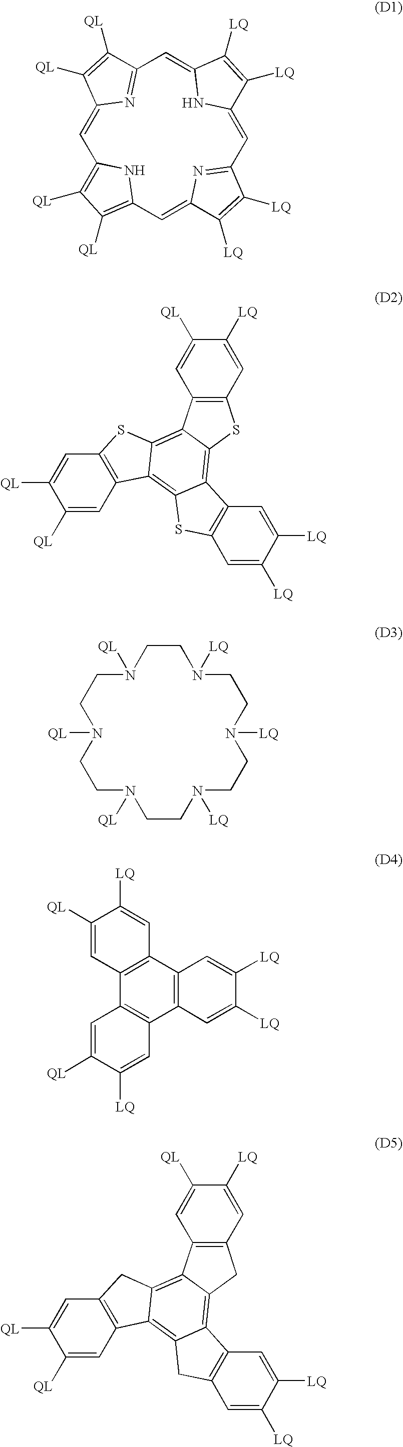

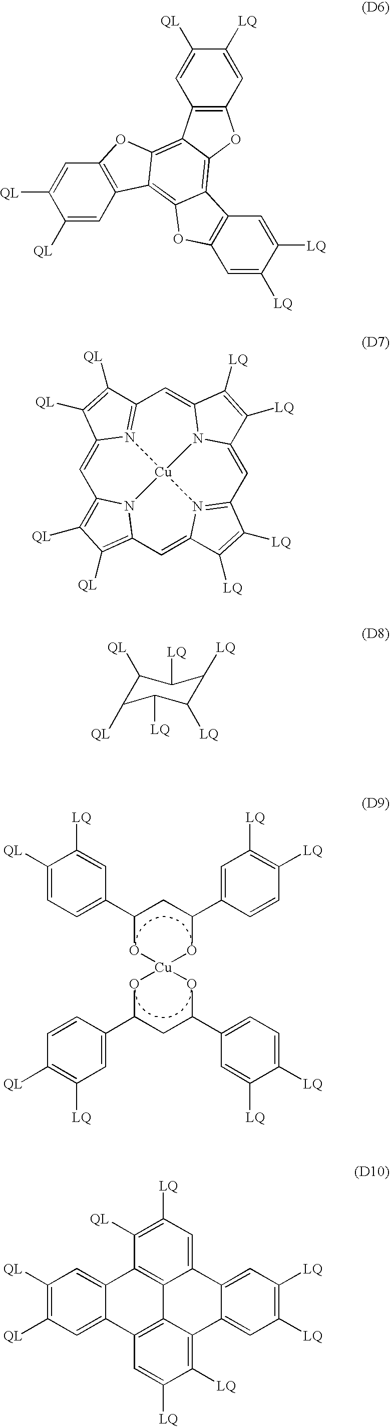

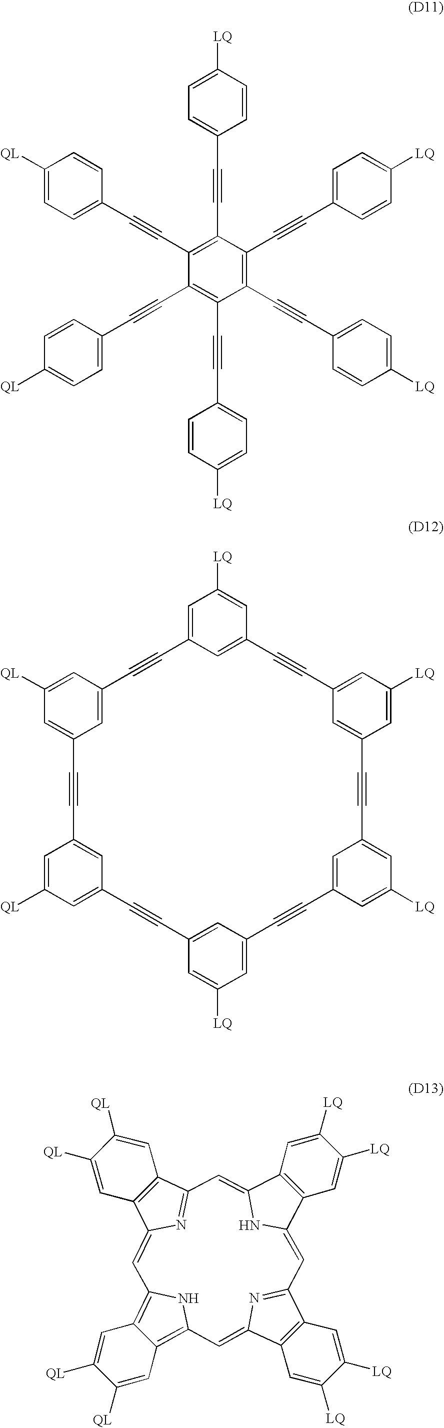

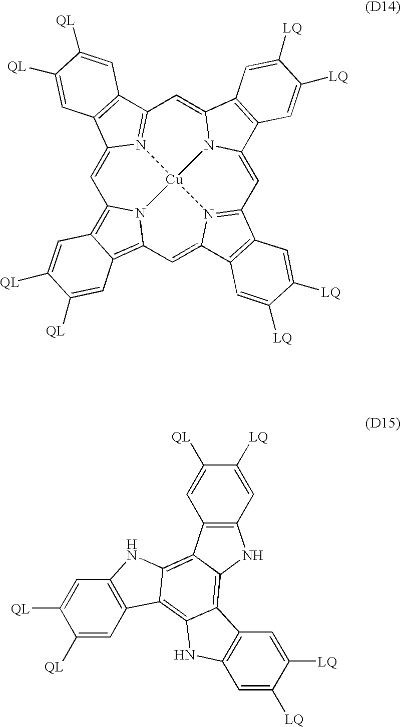

In formula (III), the divalent connecting group (L) is preferably a divalent connecting group selected from the group consisting of alkylene group, alkenylene group, arylene group, —CO—, —NH—, —O—, —S— and combination thereof. More preferably, the divalent connecting group (L) is a divalent connecting group having at least two divalent groups selected from the group consisting of alkylene group, arylene group, —CO—, —NH—, —O— and —S— in combination. Most preferably, the divalent connecting group (L) is a divalent connecting group having at least two divalent groups selected from the group consisting of alkylene group, arylene group, —CO— and —O — in combination. The number of carbon atoms in the alkylene group is preferably from 1 to 12. The number of carbon atoms in the alkenylene group is preferably from 2 to 12. The number of carbon atoms in the arylene group is preferably from 6 to 10.

Examples of the divalent connecting group (L) will be given below. These divalent connecting groups each are connected to the discotic core (D) at the left side thereof and to the polymerizable group (Q) at the right side thereof. AL means an alkylene group or alkenylene group. AR means an arylene group. The alkylene group, alkenylene group and arylene group may have substituents (e.g., alkyl group).
L1: —AL—CO—O—AL—
L2: —AL—CO—O—AL—O—
L3: —AL—CO—O—AL—O—AL—
L4: —AL—CO—O—AL—O—CO—
L5: —CO—AR—O—AL—
L6: —CO—AR—O—AL—O—
L7: —CO—AR—O—AL—O—CO—
L8: —CO—NH—AL—
L9: —NH—AL—O—
L10: —NH—AL—O—CO—
L11: —O—AL—
L12: —O—AL—O—
L13: —O—AL—O—CO—
L14: —O—AL—O—CO—NH—AL—
L15: —O—AL—S—AL—
L16: —O—CO—AR—O—AL—CO—
L17: —O—CO—AR—O—AL—O—CO—
L18: —O—CO—AR—O—AL—O—AL—O—CO—
L19: —O—CO—AR—O—AL—O—AL—O—AL—O—CO—
L20: —S—AL—
L21: —S—AL—O—
L22: —S—AL—O—CO—
L23: —S—AL—S—AL—
L24: —S—AR—AL—

In formula (III), the polymerizable group (Q) is determined by the kind of polymerization reaction. The polymerizable group (Q) is preferably an unsaturated polymerizable group or epoxy group, more preferably an unsaturated polymerizable group, most preferably an ethylenically unsaturated polymerizable group.

In formula (III), n represents an integer of from 4 to 12. In some detail, the value of n is determined by the kind of the discotic core (D). A plurality of combinations of L and Q may be different but is preferably the same.

In hybrid alignment, the angle of the major axis (disc surface) of the discotic compound with respect to the surface of the support, i.e., angle of tilt increases or decreases in the thickness direction of the optically anisotropic layer with the rise of the distance from the surface of the polarizer. The angle of tilt preferably decreases with the rise of the distance from the surface of the polarizer. The change of tilt angle may be a continuous increase, a continuous decrease, an intermittent increase, an intermittent decrease, a change involving continuous increase and continuous decrease or an intermittent change involving increase and decrease. The intermittent change involves a region in which the tilt angle shows no change in the course of thickness direction. Even when such a region in which the tilt angle shows no change is involved, it suffices if the tilt angle increases or decreases as a whole. However, the tilt angle preferably shows continuous change.

The average direction of the major axis (disc surface) of the discotic compound (average of major axis of the various discotic molecules) can be normally adjusted by properly selecting the material of the discotic compound or alignment film or the rubbing method. Further, the direction of the major axis (disc surface) of the discotic compound on the surface side (air side) can be normally adjusted by properly selecting the kind of the discotic compound or the additives to be used with the discotic compound. Examples of the additives to be used with the discotic compound include plasticizers, surface active agents, and polymerizable monomers and polymers. The degree of change of the direction of alignment of the major axis can be adjusted by properly selecting the liquid crystal molecules and the additives as in the aforementioned case.

The plasticizer, surface active agent and polymerizable monomer to be used with the discotic compound preferably have compatibility with the discotic compound to cause the change of the tilt angle of the discotic compound. Alternatively, these additives preferably never inhibit the alignment of the discotic compound. Preferred among these additive components are polymerizable monomers (e.g., compounds having vinyl group, vinyloxy group, acryloyl group or methacryloyl group). The amount of the aforementioned compounds to be added is normally from 1% to 50% by mass, preferably from 5% to 30% by mass based on the amount of the discotic compound. When monomers having four or more polymerizable reactive functional groups are used in admixture, the adhesion between the alignment film and the optically anisotropic layer can be enhanced.

The optically anisotropic layer may comprise the aforementioned fluoroaliphatic polymer according to the invention incorporated therein. Other polymers may be used with the discotic compound. These polymers preferably have some compatibility with the discotic compound to cause the change of tilt angle of the discotic compound.

Examples of the polymers employable herein include cellulose esters. Preferred examples of the cellulose esters include cellulose acetate, cellulose acetate propionate, hydroxypropyl cellulose, and cellulose acetate butyrate. The amount of the aforementioned polymers to be added is preferably from 0.1% to 10% by mass, more preferably from 0.1% to 8% by mass, even more preferably from 0.1% to 5% by mass based on the amount of the discotic compound to prevent the inhibition of the alignment of the discotic compound.

The discotic nematic liquid crystal phase-solid phase transition temperature of the discotic compound is preferably from 70° C. to 300° C., more preferably from 70° C. to 170° C.

(Fixing of Alignment of Liquid Crystal Molecule)

The liquid crystal molecules thus aligned can be fixed aligned. The fixing of alignment is preferably carried out by polymerization reaction. Examples of the polymerization reaction include heat polymerization reaction involving the use of a heat polymerization initiator and photopolymerization reaction involving the use of a photopolymerization initiator. The photopolymerization reaction is preferred.

Examples of the photopolymerization initiator include α-carbonyl compounds (disclosed in U.S. Pat. Nos. 2,367,661 and 2,367,670), acyloin ethers (disclosed in U.S. Pat. No. 2,448,828), α-hydrocarbon-substituted aromatic acyloin compounds (disclosed in U.S. Pat. No. 2,722,512), polynuclear quinone compounds (disclosed in U.S. Pat. Nos. 3,046,127 and 2,951,758), combinations of triaryl imidazole dimer and p-aminophenyl ketone (disclosed in U.S. Pat. No. 3,549,367), acridine and phenazine compounds (disclosed in JP-A-60-105667 and U.S. Pat. No. 4,239,850), and oxadiazole compounds (disclosed in U.S. Pat. No. 4,212,970).

The amount of the photopolymerization initiator to be used is preferably from 0.01 % to 20% by mass, more preferably from 0.5% to 5% by mass based on the solid content of the coating solution.

As the light beam to be emitted for the polymerization of the liquid crystal molecules there is preferably used ultraviolet ray.

The radiation energy is preferably from 20 mJ/cm2 to 50 J/cm2, more preferably from 20 mJ/cm2 to 5,000 mJ/cm2, even more preferably from 100 mJ/cm2 to 800 mJ/cm2. In order to accelerate the photopolymerization reaction, radiation may be effected under heating.

A protective layer may be provided on the optically anisotropic layer.

(Polarizer)

The optical film of the invention may be stuck to a polarizing plate or used as a protective film for polarizing plate to remarkably exhibit its capacity.

The polarizer of the invention is preferably a coated polarizer such as those produced by Optiva Inc. or a polarizer made of a binder and an iodine or dichroic dye.

Iodine and the dichroic dye in the polarizer are aligned in the binder to exhibit its polarizing capacity. Iodine and the dichroic dye are preferably aligned along the binder molecules. Alternatively, the dichroic dye is preferably self-organized as in liquid crystal so that it is aligned in one direction.

It is usual at present that general-purpose polarizers are prepared by dipping a stretched polymer in an iodine or dichroic dye solution in a bath so that the binder is impregnated with iodine or dichroic dye.

In the general-purpose polarizer, iodine or dichroic dye is distributed in the polarizer over a range from the surface of the polymer to a depth of about 4 μm (about 8 μm in total). In order to obtain sufficient polarizing properties, the general-purpose polarizer needs to have a thickness of at least 10 μm. The degree of penetration can be controlled by the concentration of iodine or dichroic dye solution, the temperature of the iodine or dichroic dye bath and the dipping time.

As mentioned above, the lower limit of the thickness of the binder is preferably 10 μm. On the other hand, the upper limit of the thickness of the binder is not specifically limited but is preferably as small as possible from the standpoint of prevention of light leakage which would occur when the polarizing plate is used in liquid crystal displays.

The thickness of the binder is preferably not greater than the thickness of the present general-purpose polarizing plate (about 30 μm), more preferably 25 μm or less, even more preferably 20 μm or less. When the thickness of the binder is 20 μm or less, light leakage can be difficultly observed with 17-inch liquid crystal displays.

The binder for the polarizer may be crosslinked. As the crosslinked binder there may be used a polymer which can be crosslinked itself. Polymers or binders obtained by introducing a functional group into the polymers can be reacted with each other by light, heat or pH change to form a polarizer.

The polymer may be provided with a crosslinked structure in the presence of a crosslinking agent. The introduction of the crosslinked structure can be carried out by introducing a connecting group derived from a crosslinking agent which is a highly active compound into the gap between the binder molecules in the presence of the crosslinking agent.

Crosslinking is normally carried out by spreading a coating solution containing a polymer or a mixture of a polymer and a crosslinking agent over a transparent support, and then heating the coated material. It suffices if the desired durability can be assured at the stage of final product. Therefore, crosslinking may be effected at any step until the step of obtaining the final polarizing plate.

As the binder for polarizer there may be used any of polymers which can be crosslinked themselves and polymers which can be crosslinked by a crosslinking agent. Examples of these polymers include polymethyl methacrylates, polyacrylic acids, polymethacrylic acids, polystyrenes, gelatins, polyvinyl alcohols, modified polyvinyl alcohols, poly(N-methylolacrylamide), polyvinyltoluenes, chlorosulfonated polyethylenes, nitrocelluloses, chlorinated polyolefins (e.g., polyvinyl chloride), polyesters, polyimides, polyvinyl acetates, polyethylenes, carboxymethyl celluloses, polypropylenes, and polycarbonates and copolymers thereof (e.g., acrylic acid-methacrylic acid copolymer, styrene-maleinimide copolymer, styrene-vinyltoluene copolymer, vinyl acetate-vinyl chloride copolymer, ethylene-vinyl acetate copolymer). Water-soluble polymers (e.g., poly(N-methylolacrylamide), carboxymethyl cellulose, gelatin, polyvinyl alcohol, modified polyvinyl alcohol) are preferably used. Gelatins, polyvinyl alcohols and modified polyvinyl alcohols are more preferably used. Polyvinyl alcohols and modified polyvinyl alcohols are most preferably used.

The percent saponification of the polyvinyl alcohol and modified polyvinyl alcohol is preferably from 70% to 100%, more preferably from 80% to 100%, most preferably from 95% to 100%. The polymerization degree of the polyvinyl alcohol is preferably from 100 to 5,000.

The modified polyvinyl alcohol is obtained by subjecting a polyvinyl alcohol to copolymerization modification, chain transfer modification or block polymerization modification so that a modifying group is introduced thereinto. In the copolymerization modification process, as modifying groups there can be introduced various groups such as COONa, Si(OH)₃, N(CH₃)₃Cl, C₉H₁₉COO, SO₃Na and C₁₂H₂₅. In the chain transfer modification process, as modifying groups there can be introduced various groups such as COONa, SH and SC₁₂H₂₅. The polymerization degree of the modified polyvinyl alcohol is preferably from 100 to 3,000. For the details of modified polyvinyl alcohols, reference can be made to JP-A-8-338913, JP-A-9-152509 and JP-A-9-316127.

Unmodified polyvinyl alcohols and alkylthio-modified polyvinyl alcohols having a percent saponification of from 85% to 95% are particularly preferably preferred.

Two or more of polyvinyl alcohols and modified polyvinyl alcohols may be used in combination.

When the binder crosslinking agent is added in a large amount, the moist heat resistance of the polarizer can be enhanced. However, when the crosslinking agent is added in an amount of 50% by mass or more based on the amount of the binder, the alignability of iodine or dichroic dye is lowered. The amount of the crosslinking agent to be added is preferably from 0.1% to 20% by mass, more preferably from 0.5% to 15% by mass based on the amount of the binder.

The binder contains unreacted crosslinking agent in some amount even after the termination of the crosslinking reaction. However, the amount of the crosslinking agent left unreacted is preferably 1.0% by mass or less, more preferably 0.5% by mass or less based on the amount of the binder. When the binder layer contains a crosslinking agent in an amount of more than 1.0% by mass, the resulting polarizer may leave something to be desired in durability. In other words, when a liquid crystal display having a polarizer having a great residual crosslinking agent content incorporated therein is used over an extended period of time or allowed to stand in a high temperature and humidity atmosphere, the polarization can be deteriorated.

For the details of the crosslinking agent, reference can be made to U.S. Reissued Pat. No. 23,297. Boron compounds (e.g., boric acid, borax), too, can be used as crosslinking agents.

As the dichroic dye there may be used any of azo-based dyes, stilbene-based dyes, pyrazolone-based dyes, triphenylmethane-based dyes, oxazine-based dyes, thiazine-based dyes and anthraquinone-based dyes. The dichroic dye is preferably water-soluble. The dichroic dye preferably has a hydrophilic substituent (e.g., sulfo, amino, hydroxyl).

Examples of the dichroic dye employable herein include C. I. direct yellow 12, C. I. direct orange 39, C. I. direct orange 72, C. I. direct red 39, C. I. direct red 79, C. I. direct red 81, C. I. direct red 83, C. I. direct red 89, C. I. direct violet 48, C. I. direct blue 67, C. I. direct blue 90, C. I. direct green 59, and C. I. direct red 37. For the details of the dichroic dye, reference can be made to JP-A-1-161202, JP-A-1-172906, JP-A-1-172907, JP-A-1-183602, JP-A-1-248105, JP-A-1-265205, and JP-A-7-261024.

The dichroic dye is used in the form of free acid, alkaline metal salt, ammonium salt or amine salt. By blending two or more dichroic dyes, polarizers having various hues can be produced. A polarizer comprising a compound (dye) which assumes black when the polarization axes are disposed perpendicular to each other or a polarizer or plate which has various dichroic molecules incorporated therein such that black is assumed is excellent in single plate transmission and percent polarization to advantage.

In order to enhance the contrast ratio of the liquid crystal display, the polarizing plate to be used preferably has a high transmission as well as a high polarization. The transmission of the polarizing plate at a wavelength of 550 nm is preferably from 30% to 50%, more preferably from 35% to 50%, most preferably from 40% to 50% (The maximum single plate transmission of the polarizing plate is 50%). The polarization of the polarizing plate at a wavelength of 550 nm is preferably from 90% to 100%, more preferably from 95% to 100%, most preferably from 99% to 100%.

The polarizer and the optically anisotropic layer or the polarizer and the alignment layer can be disposed with an adhesive interposed therebetween. As the adhesive there may be used a polyvinyl alcohol-based resin (including acetoacetyl group-, sulfone group-, carboxyl group- or oxyalkylene group-modified polyvinyl alcohols) or an aqueous solution of a boron compound. Preferred among these adhesives is polyvinyl alcohol-based resin. The dried thickness of the adhesive layer is preferably from 0.01 μm to 10 μm, particularly preferably from 0.05 μm to 5 μm.

(Production of Polarizing Plate)

In the production of the polarizer, the binder is preferably stretched at an angle of from 10° to 80° from the longitudinal direction (MD direction) of the polarizer (stretching method) or rubbed (rubbing method) before being dyed with iodine or dichroic dye from the standpoint of yield. The tilt angle preferably coincides with the angle of the transmission axis of two sheets of polarizing plate stuck to the both sides of the liquid crystal cell constituting LCD with respect to the longitudinal or crosswise direction of the liquid crystal cell.

The tilt angle is normally 45°. In recent years, however, transmission type, reflection type and semi-transmission type liquid crystal displays the tile angle of which are not necessarily 45° have been developed. It is preferred that the stretching direction be arbitrarily adjusted according to the design of LCD.

In the stretching method, the draw ratio is preferably from 2.5 to 30.0, more preferably from 3.0 to 10.0. Stretching can be effected in a dry process in the air. Alternatively, stretching may be effected in a wet process in water. The draw ratio in the dry stretching process is preferably from 2.5 to 5.0. The draw ratio in the wet stretching process is preferably from 3.0 to 10.0. Stretching may be effected batchwise, including oblique stretching. When stretching is effected batchwise, the film can be stretched more uniformly even at a high draw ratio. The film may be stretched crosswise or longitudinally to some extent (such that the crosswise shrinkage can be prevented) before being obliquely stretched.

Stretching can be carried out by effecting tenter stretching in biaxial stretching in manners which are different from right to left. The aforementioned biaxial stretching method is the same as the stretching method practiced in the ordinary film making method. In the biaxial stretching method, the film is stretched at speeds which are different from right to left. It is therefore necessary that the thickness of the unstretched binder film differ from right to left. In the film making method involving flow casting, the die used can be tapered to make the flow rate of binder solution different from right to left.

Thus, a binder film which has been obliquely stretched at an angle of from 10° to 80° from MD direction of the polarizer.

As the aforementioned rubbing treatment there may be used one which is widely employed as liquid crystal alignment for LCD. In some detail, the surface of the alignment layer may be rubbed with paper, gauze, felt, rubber, nylon, polyester fiber or the like in a constant direction to attain alignment. In general, the surface of the film is rubbed with a cloth having fibers having uniform length and thickness planted uniformly thereon several times. Rubbing is preferably effected using a rubbing roll having a roundness, a cylindricality and a deflection (eccentricity) of 30 μm or less. The angle of lapping of the film on the rubbing roll is preferably from 0.1° to 90°. However, as disclosed in JP-A-8-160430, stable rubbing can be made by winding the film on the rubbing roll at a lapping angle of 360° or more.

In the case where a film of continuous length is subjected to rubbing, it is preferred that the film be conveyed at a speed of from 1 to 100 m/min while being kept at a constant tension. The rubbing roll is preferably arranged swingable in the horizontal direction against the direction of conveyance of the film so that arbitrary rubbing angle can be predetermined. A proper rubbing angle is predetermined within a range of from 0° to 60°. In the case where the film is used in liquid crystal displays, the rubbing angle of is preferably from 40° to 50°, particularly preferably 45°.

A polymer film is preferably provided on the surface of the polarizer on the side thereof opposite the optically anisotropic layer (optically anisotropic layer/polarizer/polymer film).

Constituent materials required for optical film will be described hereinafter.

(Support)

The support of the invention is preferably glass or a transparent polymer film.

The support preferably exhibits a light transmittance of 80% or more. Examples of the polymer constituting the polymer film include cellulose esters (e.g., cellulose triacetate, cellulose diacetate), norbornene-based polymers, and polymethyl methacrylates. Commercially available polymers (including Arton and Zeonex (trade name)) may be also used.

Preferred among these polymers are cellulose esters. Lower aliphatic acid esters of cellulose are more desirable. The term “lower aliphatic acid” as used herein is meant to indicate an aliphatic acid having 6 or less carbon atoms. The number of carbon atoms in the aliphatic acid is preferably 2 (cellulose acetate), 3 (cellulose propionate) or 4 (cellulose butyrate). Cellulose acetate is particularly preferred. A mixed aliphatic acid ester such as cellulose acetate propionate and cellulose acetate butyrate may be also used.

Even a polymer which can easily exhibit birefringence such as polycarbonate and polysulfone, that have heretofore been known, can be used as optical film of the invention when controlled in development of birefringence by modifying its molecules as disclosed in WO'00/26705.

In the case where the optical film of the invention is used as protective film for polarizing plate or retardation film, as the polymer film there is preferably used a cellulose acetate having an acetylation degree of from 55.0% to 62.5%, more preferably from 57.0% to 62.0%.

The term “acetylation degree” as used herein is meant to indicate the mass of acetic acid bonded per mass of glucopyranose unit. The acetylation degree is determined by the measurement and calculation of acylation degree according to ASTM: D-817-91 (testing method on cellulose acylate, etc.).

The viscosity-average polymerization degree (DP) of the cellulose acetate is preferably 250 or more, more preferably 290 or more. The cellulose acetate preferably has a sharp molecular weight distribution Mw/Mn (in Mw represents weight-average molecular weight and Mn represents a number-average molecular weight) as determined by gel permeation chromatography. In some detail, Mw/Mn is preferably from 1.0 to 1.7, more preferably from 1.0 to 1.65, most preferably from 1.0 to 1.6.

A cellulose acylate tends to have hydroxyl group substituted less in the 6-position rather than uniformly in the 2-position, 3-position and 6-position. The cellulose acylate to be used in the invention preferably has a cellulose substitution degree in the 6-position which is the same as or greater that that in the 2- and 3-positions.

The proportion of the substitution degree in the 6-position in the sum of the substitution degree in the 2-, 3- and 6-positions is preferably from 30% to 40%, more preferably from 31% to 40%, most preferably from 32% to 40%. The substitution degree in the 6-position is preferably 0.88 or more.

The substitution degree in the various positions can be measured by NMR.

A cellulose acetate having a high substitution degree in the 6-position can be synthesized according to Synthesis Examples 1, 2 and 3 disclosed in JP-A-11-5851, paragraph (0043)-(0044), (0048)-(0049) and (0051)-(0052), respectively.

(Liquid Crystal Display)

Preferred embodiments of the optically anisotropic layer in various liquid crystal modes will be described hereinafter.

(TN Mode Liquid Crystal Display)

A TN mode liquid crystal cell is most widely used as a color TFT liquid crystal display. For details, reference can be made to numeral literatures.

Referring to the alignment in the liquid crystal cell during the black display of TN mode, rod-shaped liquid crystal molecules are oriented vertically at the central part of the cell but horizontally in the vicinity of the substrate of the cell.

The rod-shaped liquid crystal molecules in the central portion of the cell can be compensated by homeotropically-aligned (horizontal alignment having disc surface oriented horizontally) discotic liquid crystal molecules or (transparent) support while the rod-shaped liquid crystal molecules in the vicinity of the substrate in the cell can be compensated by hybrid-aligned (alignment involving change of tilt of major axis with distance from polarizer) discotic liquid crystal molecules.

Further, the rod-shaped liquid crystal molecules in the central portion of the cell can be compensated by homogeneously-aligned (horizontal alignment having major axis oriented horizontally) rod-shaped liquid crystal molecules or (transparent) support while the rod-shaped liquid crystal molecules in the vicinity of the substrate in the cell can be compensated by hybrid-aligned discotic liquid crystal molecules.

The homeotropically-aligned liquid crystal molecules are aligned in such an arrangement that the angle of the average alignment direction of major axis of the liquid crystal molecules with respect to the surface of the polarizer is from 85° to 95°.

The homogeneously-aligned liquid crystal molecules are aligned in such an arrangement that the angle of the average alignment direction of major axis of the liquid crystal molecules with respect to the surface of the polarizer is less than 5°.

The hybrid-aligned liquid crystal molecules are aligned in such an arrangement that the angle of the average alignment direction of major axis of the liquid crystal molecules with respect to the surface of the polarizer is preferably more than 15°, more preferably from 15° to 85°.

The optically anisotropic layer having a (transparent) support or discotic compound homeotropically aligned therein, the optically anisotropic layer having rod-shaped liquid crystal molecules homogeneously aligned therein and the optically anisotropic layer made of homeotropically-aligned discotic compound and homogeneously-aligned rod-shaped liquid crystal molecules in admixture each preferably exhibit Rth retardation value of from 40 nm to 200 nm and Re retardation value of from 0 to 70 nm.

In the invention, Re and Rth represent the in-plane retardation and thickness-direction retardation at a wavelength of λ, respectively. Re can be measured by the incidence of light having a wavelength λ nm in the direction normal to the film using an automatic birefringence meter such as Type KOBRA 21ADH birefringence meter (produced by Ouji Scientific Instruments Co. Ltd.). Rth can be calculated by an automatic birefringence meter such as KOBRA 21ADH on the basis of retardation values measured in the total three directions, i.e., the Re, retardation value measured by the incidence of light having a wavelength λ nm in the direction inclined at an angle of +40° from the direction normal to the film with the in-plane slow axis (judged from “KOBRA 21ADH”) as an inclined axis (rotary axis), retardation value measured by the incidence of light having a wavelength λ nm in the direction inclined at an angle of −40° from the direction normal to the film with the in-plane slow axis as an inclined axis (rotary axis). As the hypothetical average refractive index there may be used one disclosed in “Polymer Handbook”, John Wiley & Sons, Inc. and various catalogues of optical films. For the cellulose acylate films having an unknown average refractive index, an Abbe refractometer may be used. The average refractive index of main optical films are exemplified below.

Cellulose acylate (1.48), cycloolefin polymer (1.52), polycarbonate (1.59), polymethylene methacrylate (1.49), polystyrene (1.59). By inputting the hypothetic average refractive indexes and film thicknesses, the automatic birefringence meter such as KOBRA 21ADH calculates nx, ny and nz.

For the details of homeotropically-aligned (horizontally-aligned) discotic liquid crystal molecule layer and homogeneously-aligned (horizontally-aligned) rod-shaped liquid crystal molecule layer, reference can be made to JP-A-12-304931 and JP-A-12-304932. For the details of hybrid-aligned discotic liquid crystal molecule layer, reference can be made to JP-A-8-50206.

(OCB Mode Liquid Crystal Display)

An OCB mode liquid crystal cell is a liquid crystal cell of bend alignment mode wherein rod-shaped liquid crystal molecules are oriented in substantially opposing directions (symmetrically) from the upper part to the lower part of the liquid crystal cell. A liquid crystal display comprising a bend alignment mode liquid crystal cell comprises devices disclosed in U.S. Pat. Nos. 4,583,825 and 5,410,422 oriented symmetrically with each other from the upper part to the lower part of the liquid crystal cell. Therefore, the bend alignment mode liquid crystal cell has a self optical compensation capacity. Accordingly, this liquid crystal mode is also called OCB (optically compensated bend) liquid crystal mode.

In OCB mode liquid crystal cell, too, rod-shaped liquid crystal molecules are oriented vertically at the central part of the liquid crystal cell but are oriented horizontally in the vicinity of the substrate of the cell during black display as in TN mode.

OCB mode is the same as TN mode in the alignment of liquid crystal during black display. Therefore, preferred embodiments of OCB mode correspond to that of TN mode. However, since OCB mode has a greater range of vertical orientation of liquid crystal compound molecules in the central portion of the cell than TN mode, the optically anisotropic layer having a discotic compound homeotropically aligned therein or the optically anisotropic layer having rod-shaped liquid crystal molecules homogeneously aligned therein needs to be somewhat adjusted in retardation value. In some detail, the optically anisotropic layer having a (transparent) support or discotic compound homeotropically aligned therein or the optically anisotropic layer having rod-shaped liquid crystal molecules homogeneously aligned therein preferably exhibits Rth retardation value of from 150 nm to 500 nm and Re retardation value of from 20 to 70 nm.

(VA Mode Liquid Crystal Display)

In a VA mode liquid crystal cell, rod-shaped liquid crystal molecules are vertically oriented when no voltage is applied.

VA mode liquid crystal cells include (1) liquid crystal cell in VA mode in a narrow sense in which rod-shaped liquid crystal molecules are oriented substantially vertically when no voltage is applied but substantially horizontally when a voltage is applied (as disclosed in JP-A-2-176625). In addition to the VA mode liquid crystal cell (1), there have been provided (2) liquid crystal cell of VA mode which is multidomained to expand the viewing angle (MVA mode) (as disclosed in SID97, Digest of Tech. Papers (preprint) 28 (1997), 845), (3) liquid crystal cell of mode in which rod-shaped molecules are oriented substantially vertically when no voltage is applied but oriented in twisted multidomained mode when a voltage is applied (n-ASM mode, CPA mode) (as disclosed in Preprints of Symposium on Japanese Liquid Crystal Society Nos. 58 to 59, 1998 and (4) liquid crystal cell of SURVALVAL mode (as reported in LCD International 98).

During black display of VA mode liquid crystal display, most of the rod-shaped liquid crystal molecules in the liquid crystal cell are oriented vertically. It is therefore preferred that the liquid compound be compensated by an optically anisotropic layer having a discotic compound homeotropically aligned therein or an optically anisotropic layer having rod-shaped liquid crystal molecules homogeneously aligned therein while the viewing angle dependence of the polarizing plate be compensated by an optically anisotropic layer having rod-shaped liquid crystal molecules homogeneously aligned therein wherein the angle of the average alignment direction of the major axis of the rod-shaped liquid crystal molecules with respect to the direction of the transmission axis of the polarizer is less than 5°.

The optically anisotropic layer having a (transparent) support or discotic compound homeotropically aligned therein or the optically anisotropic layer having rod-shaped liquid crystal molecules homogeneously aligned therein preferably exhibits Rth retardation value of from 150 nm to 500 nm and Re retardation value of from 20 nm to 70 nm.

(Other Liquid Crystal Displays)

ECB mode and STN mode liquid crystal displays can be optically compensated in the same idea as mentioned above.

Hereinafter, the invention will be described in more detail with reference to the following Examples, but the invention is not limited thereto.

### EXAMPLE 1

(Preparation of Polymer Substrate (i.e., One of the Aforementioned Supports))

The following components were charged in a mixing tank where they were then heated with stirring so that they were dissolved to prepare a cellulose acetate solution.

(Formulation of Cellulose Acetate Solution)

| | | |
|---|---|---|
| Cellulose acetate having an acetylation | 80 | parts by mass (weight) |
| degree of 60.9% (made of linter) | | |
| Cellulose acetate having an acetylation | 20 | parts by mass |
| degree of 60.8% (made of linter) | | |
| Triphenyl phosphate (plasticizer) | 7.8 | parts by mass |
| Biphenyl diphenyl phosphate (plasticizer) | 3.9 | parts by mass |
| Methylene chloride (first solvent) | 300 | parts by mass |
| Methanol (second solvent) | 54 | parts by mass |
| 1-Butanol (third solvent) | 11 | parts by mass |

In another mixing tank were charged 4 parts by mass of a cellulose acetate having an acetylation degree of 60.9% (made of linter), 16 parts by mass of the following retardation raising agent, 0.5 parts by mass of particulate silica (particle diameter: 20 nm; Mohs hardness: approx. 7), 87 parts by mass of methylene chloride and 13 parts by mass methanol which were then heated with stirring to prepare a retardation raising agent solution.

464 parts by mass of the cellulose acetate solution were mixed with 36 parts by mass of the retardation raising agent solution. The mixture was then thoroughly stirred to prepare a dope. The content of the retardation raising agent was 5.0 parts by mass based on 100 parts by mass of cellulose acetate.
Retardation Raising Agent

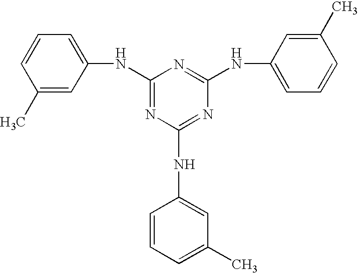

The dope thus obtained was then flow-casted using a band flow casting machine. When the film temperature on the band reached 40° C., the film was then dried for 1 minute. The film having a residual solvent content of 43% by mass was peeled off the band, and then stretched crosswise by a factor of 28% with 140° C. drying air using a tenter. Thereafter, the film was dried with 135° C. drying air for 20 minutes to produce a polymer substrate (PK-1) having a residual solvent content of 0.3% by mass.

The polymer substrate thus obtained (PK-1) had a width of 1,340 mm and a thickness of 92 μm. The polymer substrate (PK-1) was then measured for retardation value (Re) at a wavelength of 590 nm using a Type KOBRA21ADH automatic birefringence meter (produced by Ouji Scientific Instruments Co., Ltd.). The result was 43 nm. The polymer substrate (PK-1) was also measured for retardation value (Rth) at a wavelength of 590 nm. The result was 175 nm.

The polymer substrate thus obtained (PK-1) was dipped in a 2.0 N solution of potassium hydroxide (25° C.) for 2 minutes, neutralized with sulfuric acid, washed with purified water, and then dried. The polymer substrate (PK-1) thus treated was then measured for surface energy by contact angle method. The result was 63 mN/m.

An alignment film coating solution having the following formulation was then spread over the polymer substrate (PK-1) using a #16 wire bar coater at a rate of 28 ml/m2. The coated material was dried with 60° C. hot air for 60 seconds and then with 90° C. hot air for 150 seconds.

(Formulation of Alignment Film Coating Solution)

| | |
|---|---|
| Modified polyvinyl alcohol havingthe | 10 parts by mass |
| following formula | |
| Water | 371 parts by mass |
| Methanol | 119 parts by mass |
| Glutaraldehyde (crosslinking agent) | 0.5 parts by mass |

Modified Polyvinyl Alcohol

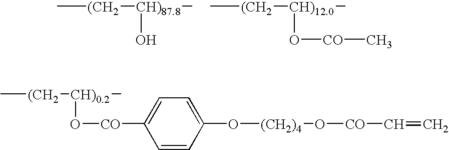

The alignment film thus was then subjected to rubbing in the direction of 45° from the slow axis (measured at a wavelength of 632.8 nm) of the polymer substrate (PK-1).

(Formation of Optically Anisotropic Layer)

41.01 Kg of the following discotic liquid crystal compound, 4.06 kg of an ethylene oxide-modified trimethylolpropane triacrylate (V#360, produced by OSAKA ORGANIC CHEMICAL INDUSTRY LTD.), 0.35 kg of cellulose acetate butyrate (CAB531-1, produced by Eastman Chemical Co., Ltd.), 1.35 kg of a photopolymerization initiator (Irgacure 907, produced by Ciba Geigy Inc.) and 0.45 kg of a sensitizer (Kayacure DETX, produced by NIPPON KAYAKU CO., LTD.) were dissolved in 102 kg of methyl ethyl ketone. To the solution thus prepared was then added 0.1 kg of a fluoroaliphatic group-containing copolymer (one having a molecular weight of 10,000 or more in a proportion of 12.8% and a molecular weight of 20,000 or less in a proportion of 63.9% obtained by subjecting Megafac F780 (produced by DAINIPPON INK AND CHEMICALS, INCORPORATED) to molecular weight cut-off) to prepare a coating solution. The coating solution thus prepared was continuously spread over the alignment film using a #3.6 wire bar, and then heated to 130° C. for 2 minutes so that the discotic liquid crystal compound was aligned. Subsequently, the film was irradiated with ultraviolet rays from a 120 W/cm high pressure mercury vapor lamp at 100° C. for 1 minute so that the discotic liquid crystal compound was polymerized. Thereafter, the film was allowed to cool to room temperature. Thus, an optically compensatory sheet (KH1-1) with optically anisotropic layer was prepared.

The Re retardation value of the optically anisotropic layer measured at a wavelength of 546 nm was 38 nm. The angle of the surface of the disc with respect to the surface of the first transparent support (tilt angle) was 33° on the average.

The optically compensatory sheet thus obtained was then observed for unevenness with the polarizing plate arranged in crossed nicols. As a result, no unevenness was detected even as viewed at front ways and at an angle of 60° from the line normal to the surface of the film.

Optically compensatory sheets KH1-2 to KH1-5 having different copolymer contents were prepared in the same manner as mentioned above except that the added amount of the fluoroaliphatic group-containing copolymer (Megafac F780 (produced by DAINIPPON INK AND CHEMICALS, INCORPORATED) was varied.
Discotic Liquid Crystal Compound 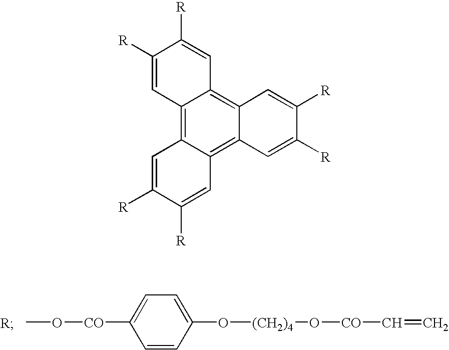
(Preparation of Polarizer)

PVA having an average polymerization degree of 4,000 and a saponification degree of 99.8 mol-% was dissolved in water to obtain a 4.0% aqueous solution. The solution thus obtained was band-casted using a tapered die, and then dried to obtain an unstretched film having a width of 110 mm and a thickness of 120 μm at the left edge thereof and 135 μm at the right edge thereof.

The film thus obtained was peeled off the band, obliquely dry-stretched in the direction of 45°, directly dipped in an aqueous solution of 0.5 g/L of iodine and 50 g/L of potassium iodide at 30° C. for 1 minute, dipped in an aqueous solution of 100 g/L of boric acid and 60 g/L of potassium iodide at 70° C. for 5 minutes, washed with water in a water bath at 20° C. for 10 minutes, and then dried at 80° C. for 5 minutes to obtain an iodine-based polarizer (HF-1). The polarizer thus obtained had a width of 660 nm and a thickness of 20 μm at the both edges thereof.

(Preparation of Polarizing Plate)

KH-1-1 to KH-1-5 (optically compensatory sheet) were each stuck to one side of the polarizer (HF-1) on the polymer substrate (PK-1) side thereof with a polyvinyl alcohol-based adhesive. A triacetyl cellulose film having a thickness of 80 μm (TD-80U, produced by Fuji Photo Film Co., Ltd.) which had been saponified was then stuck to the other side of the polarizer with a polyvinyl alcohol-based adhesive.

The polarizing plate was arranged such that the transmission axis of the polarizer and the slow axis of the polymer substrate (PK-1) were disposed parallel to each other and the transmission axis of the polarizer and the slow axis of the aforementioned triacetyl cellulose film were disposed perpendicular to each other. Thus, polarizing plates (HB1-1 to HB1-5) were prepared.

### Comparative Example 1

An optically compensatory sheet (KU-HI) was prepared in the same manner as in Example 1 except that the optically anisotropic layer comprised a fluoroaliphatic group-containing copolymer (Megafac F780, produced by DAINIPPON INK AND CHEMICALS, INCORPORATED) incorporated therein. Further, a polarizing plate with KH-H1 (HB-H1) was prepared.

### EXAMPLE 2

(Preparation of Polymer Substrate)

In a mixing tank were charged 16 parts by mass of the retardation raising agent as used in Example 1, 80 parts by mass of methylene chloride and 20 parts by mass methanol which were then heated with stirring to prepare a retardation raising agent solution.

474 parts by mass of the cellulose acetate solution prepared in Example 1 were mixed with 25 parts by mass of the retardation raising agent solution. The mixture was then thoroughly stirred to prepare a dope. The amount of the retardation raising agent to be incorporated was 3.5 parts by mass based on 100 parts by mass of cellulose acetate.

The dope thus obtained was then flow-casted using a band flow casting machine. When the film temperature on the band reached 40° C., the film was then dried for 1 minute, peeled off the band, and then dried with 140° C. drying air to produce a polymer substrate (PK-2) having a residual solvent content of 0.3% by mass.

The polymer substrate thus obtained (PK-2) had a width of 1,500 mm and a thickness of 65 μm. The polymer substrate (PK-2) was then measured for retardation value (Re) at a wavelength of 590 nm using a Type KOBRA21ADH automatic birefringence meter (produced by Ouji Scientific Instruments Co., Ltd.). The result was 4 nm. The polymer substrate (PK-1) was also measured for retardation value (Rth) at a wavelength of 590 nm. The result was 78 nm.

(Preparation of Optically Compensatory Sheet with Optically Anisotropic Layer)

The polymer substrate thus obtained (PK-2) was dipped in a 2.0 N solution of potassium hydroxide (25° C.) for 2 minutes, neutralized with sulfuric acid, washed with purified water, and then dried. The polymer substrate PK-2 thus treated was then measured for surface energy by contact angle method. The result was 63 mN/m.

<Formation of alignment film>

A coating solution having the following formulation was then spread over the polymer substrate (PK-2) using a #16 wire bar coater at a rate of 28 ml/m2. The coated material was dried with 60° C. hot air for 60 seconds and then with 90° C. hot air for 150 seconds.

<Formulation of alignment film coating solution>

| | |
|---|---|
| Modified polyvinyl alcohol of | 10 parts by mass |
| Example 1 | |
| Water | 371 parts by mass |
| Methanol | 119 parts by mass |
| Glutaraldehyde (crosslinking agent) | 0.5 parts by mass |

Subsequently, the modified polyvinyl film was subjected to rubbing in such a manner that the film was aligned in the direction parallel to the longitudinal direction of PK-2.

(Formation of Optically Anisotropic Layer)

41.01 Kg of the discotic liquid crystal compound of Example 1, 4.06 kg of an ethylene oxide-modified trimethylolpropane triacrylate (V#360, produced by OSAKA ORGANIC CHEMICAL INDUSTRY LTD.), 0.90 kg of cellulose acetate butyrate (CAB551-0.2, produced by Eastman Chemical Co., Ltd.), 0.23 kg of cellulose acetate butyrate (CAB531-1, produced by Eastman Chemical Co., Ltd.), 1.35 kg of a photopolymerization initiator (Irgacure 907, produced by Ciba Geigy Inc.) and 0.45 kg of a sensitizer (Kayacure DETX, produced by NIPPON KAYAKU CO., LTD.) were dissolved in 102 kg of methyl ethyl ketone. To the solution thus prepared was then added 0.1 kg of a fluoroaliphatic group-containing copolymer (P-29) to prepare a coating solution. The coating solution thus prepared was spread over the alignment film using a #3.4 wire bar. The coated material was heated in a 130° C. constant temperature zone for 2 minutes so that the discotic liquid crystal compound was aligned. Subsequently, the film was irradiated with ultraviolet rays from a 120 W/cm high pressure mercury vapor lamp in a 60° C. atmosphere for 1 minute so that the discotic liquid crystal compound was polymerized. Thereafter, the film was allowed to cool to room temperature. Thus, an optically compensatory sheet (KH2-1) with optically anisotropic layer was prepared.

The Re retardation value of the optically anisotropic layer measured at a wavelength of 546 nm was 40 nm. The angle of the surface of the disc with respect to the surface of the first transparent support (tilt angle) was 39° on the average.

The optically compensatory sheet thus obtained was then observed for unevenness with the polarizing plate arranged in crossed nicols. As a result, no unevenness was detected even as viewed at front ways and at an angle of 60° from the line normal to the surface of the film.

Optically compensatory sheets KH2-2 to KH2-4 having different copolymer contents were prepared in the same manner as mentioned above except that the added amount of the fluoroaliphatic group-containing copolymer (Megafac F780 (produced by DAINIPPON INK AND CHEMICALS, INCORPORATED) was varied.

(Preparation of Polarizing Plate)

KH2-1 to KH2-4 (optically compensatory sheet) were each stuck to one side of the polarizer (HF-1) with a polyvinyl alcohol-based adhesive. A triacetyl cellulose film having a thickness of 80 μm (TD-80U, produced by Fuji Photo Film Co., Ltd.) which had been saponified was then stuck to the other side of the polarizer with a polyvinyl alcohol-based adhesive.

The polarizing plate was arranged such that the transmission axis of the polarizer and the slow axis of the polymer substrate (PK-2) were disposed parallel to each other and the transmission axis of the polarizer and the slow axis of the aforementioned triacetyl cellulose film were disposed perpendicular to each other. Thus, polarizing plates (HB2-1 to HB-2-4) were prepared.

(Preparation of Bend-Aligned Liquid Crystal Cell)

A polyimide layer was provided as an alignment layer on a glass substrate with ITO electrode. The alignment layer was subjected to rubbing. Two sheets of the glass substrates thus obtained were stacked on each other in such an arrangement that the rubbing direction of the two sheets are parallel to each other. The cell gap was predetermined to be 6 μm. Into the cell gap was then injected a liquid crystal compound having Δn (difference between refractive index ne and n0) of 0.1396 “ZLI1132” (produced by Melc Co., Ltd.) to prepare a bend-aligned liquid crystal cell. The size of the liquid crystal cell was 20 inch.

Two sheets of each of the polarizing plates prepared in Examples 1 and 2 and Comparative Example 1 (HB1-1 to HB1-5, HB2-1 to HB2-4 and HB-H1) were stuck to each other with the bend-aligned cell thus prepared interposed therebetween. The arrangement was made such that the optically anisotropic layer of the ellipsoidal polarizing plate was opposed to the cell substrate and the rubbing direction of the liquid crystal cell and the rubbing direction of the optically anisotropic layer opposed thereto were not parallel to each other.

A rectangular waveform voltage of 55 Hz was applied to the liquid crystal cell. The liquid crystal cell was of normally white mode that makes white display at 2 V and black display at 5 V. With the transmission ratio (white display/black display) as contrast ratio, the liquid crystal cell was measured for viewing angle at 8 stages ranging from black display (L1) to white display (L8) using a Type EZ-Contrast 160D (produced by ELDIM).

(Evaluation of Unevenness on Liquid Crystal Display Panel)

The display panel of the liquid crystal displays of Examples 1 and 2 and Comparative Example 1 were entirely adjusted half-tone to make evaluation of unevenness. Example 1 was observed to show no unevenness even as viewed from any direction. However, Comparative Example 1 was observed to show lattice-like unevenness as viewed at an upper angle of 45° or more.

(Evaluation on TN Liquid Crystal Cell)

A pair of polarizing plates were peeled off a Type AQUOS LC20C1 S liquid crystal display comprising a TN type liquid crystal cell (produced by SHARP CORPORATION). Instead of these polarizing plates, the polarizing plates (HB2-1 to HB2-4) prepared in Example 2 were each stuck to the observer side and the backlight side of the liquid crystal cell, respectively, with an adhesive in such an arrangement that the optically compensatory sheets (KH2-1 to KH2-4) were on the liquid crystal side.

The transmission axis of the polarizing plate on the observer side and the transmission axis of the polarizing plate on the backlight side were disposed such that O mode was established.

The liquid crystal displays thus prepared were each then measured for viewing angle at 8 stages ranging from black display (L1) to white display (L8) using a Type EZ-Contrast 160D (produced by ELDIM).

(Evaluation of Unevenness on Liquid Crystal Display Panel)

The display panel of the liquid crystal displays of Example 2 was entirely adjusted half-tone to make evaluation of unevenness. The display panel was observed to show no unevenness even as viewed from any direction.

### EXAMPLE 3

(Formation of Optically Anisotropic Layer)

A commercially available triacetyl cellulose film (Fujitac, produced by Fuji Photo Film Co., Ltd.) was dipped in a 2.0 N solution of potassium hydroxide (25° C.) for 2 minutes, neutralized with sulfuric acid, washed with purified water, and then dried. The polymer substrate thus obtained was referred to as “PK-3”. The polymer substrate PK-3 was then measured for surface energy by contact angle method. The result was 63 mN/m.

<Formation of alignment film>

A coating solution having the following formulation was spread over the aforementioned Fujitac film at a rate of 28 ml/m2 using a #16 wire bar coater, and then dried with 60° C. hot air for 60 seconds and then with 90° C. hot air for 150 seconds.

<Formulation of alignment film coating solution>

| | |
|---|---|
| Modified polyvinyl alcohol of | 10 parts by mass |
| Example 1 | |
| Water | 371 parts by mass |
| Methanol | 119 parts by mass |
| Glutaraldehyde (crosslinking agent) | 0.5 parts by mass |

90 parts by mass of the discotic compound of Example 1, 10 parts by mass of an ethylene oxide-modified trimethylolpropane triacrylate (V#360, produced by OSAKA ORGANIC CHEMICAL INDUSTRY LTD.), 0.6 parts by mass of melamine formaldehyde/acrylic acid copolymer (Aldrich reagent), 3.0 parts by mass of a photopolymerization initiator (Irgacure 907, produced by Ciba Geigy Inc.) and 1.0 kg of a photosensitizer (Kayacure DETX, produced by NIPPON KAYAKU CO., LTD.) were dissolved in methyl ethyl ketone to prepare a solution having a solid content concentration of 38% by mass. To the solution thus obtained was then added 0.5 kg of the fluoroaliphatic group-containing copolymer (P-45) to prepare a coating solution.

The coating solution was spread over the alignment film in the same amount as in Example 2, and then dried. The coated material was heated to 130° C. for 1 minute so that the discotic compound was aligned. The coated material was immediately cooled to room temperature, irradiated with ultraviolet rays at a dose of 500 mJ/cm2 so that the discotic compound was polymerized to fixed alignment. Thus, an optically compensatory sheet (KH3-1) was prepared. The optically anisotropic layer thus formed had a thickness of 1.7 μm.

The optically anisotropic layer was then measured for angle dependence of retardation using an ellipsometer (produced by JASCO). As a result, the angle of the disc surface with respect to the alignment film surface of the discotic compound was 0.2° and the thickness-direction retardation (Rth) of the optically anisotropic layer was 150 nm.

Optically compensatory sheets KH3-2 to KH3-7 having different copolymer contents were prepared in the same manner as in the optically compensatory sheet (KH3-1) except that the added amount of the fluoroaliphatic group-containing copolymer (Megafac F780 (produced by DAINIPPON INK AND CHEMICALS, INCORPORATED) was varied.

(Preparation of Polarizing Plate)

KH3-1 to KH3-7 were each stuck to one side of the polarizer (HF-1) with a polyvinyl alcohol-based adhesive. A triacetyl cellulose film having a thickness of 80 μm (TD-80U, produced by Fuji Photo Film Co., Ltd.) which had been saponified was then stuck to the other side of the polarizer with a polyvinyl alcohol-based adhesive.

The polarizing plate was arranged such that the transmission axis of the polarizer (HF-1) and the slow axis of the optically compensatory sheets KH3-1 to KH3-7 were disposed parallel to each other and the transmission axis of the polarizer and the slow axis of the aforementioned triacetyl cellulose film were disposed perpendicular to each other. Thus, polarizing plates (HB3-1 to HB3-7) were prepared.

(Vertically Aligned Liquid Crystal Cell)

A pair of polarizing plates and a pair of retardation plates were peeled off a Type VL-1530S comprising a vertically aligned liquid crystal cell (VL-1530S, produced by Fujitsu Limited). Instead of these polarizing plates and retardation plates, the polarizing plate (HB-3) was stuck to the liquid crystal cell with an adhesive in such an arrangement that the polymer substrate (PF-1) was on the liquid crystal side. The arrangement was made in crossed nicols such that the transmission axis of the polarizing plate on the observer side was disposed vertically and the transmission axis of the polarizing plate on the backlight side was disposed horizontally.

(Evaluation of Unevenness on Panel)

The liquid crystal displays of Example 3 were entirely adjusted half-tone to make evaluation of unevenness. The liquid crystal display was observed to show no unevenness even as viewed from any direction.

(Evaluation of Results)

The results of evaluation of drying unevenness and streak on the optical films of Examples 1, 2 and 3 of the invention and the comparative optical films thus prepared are set forth in Table 1.

For AR-XPS process measurement, JPS-9000MX (produced by JEOL) was used. As X ray there was used MG-Kα ray of 10 kV-10 mA. Referring to the measurement conditions, the pass energy was 20 eV, the step was 0.2 eV, the dwell time was 0.1 seconds and four integrations were conducted. The measurement was made at angle φ of 90°, 45°, 30° and 20° between the surface of the sample and the directional axis of the detector. As the sample to be measured there was used one having a size of 2 cm ×2 cm cut from the optically compensatory sheet prepared in the same manner as in JP-A-2004-198511.

Referring to the evaluation of surface conditions, a layered product of the polarizing plate on the optically compensatory sheet prepared in the same manner as in JP-A-2004-198511 was observed. The evaluation was made according to the 7-step criterion (PP-EEE) set forth as evaluation levels in Table 1 below.

Both the comparative and inventive examples were measured in the same manner.

TABLE 1

| | | | Evaluation of | |
|---|---|---|---|---|
| | φ = 20 | φ = 30 | surface conditions | |
| | CFn peak | CFn peak | Drying | |
| | ratio P(%) | ratio P(%) | unevenness | Streak |
| Comparative Example 1 | 26 | 17 | PP | P |
| (Sheet KH-H1) | | | | |
| Inventive Example 1-1 | 24 | 18 | F | F |
| (Sheet KH1-1) | | | | |
| Inventive Example 1-2 | 24 | 17 | G | G |
| (Sheet KH1-2) | | | | |
| Inventive Example 1-3 | 24 | 18 | E | E |
| (Sheet KH1-3) | | | | |
| Inventive Example 1-4 | 23 | 18 | EE | E |
| (Sheet KH1-4) | | | | |
| Inventive Example 1-5 | 23 | 17 | E | EE |
| (Sheet KH1-5) | | | | |
| Inventive Example 2-1 | 26 | 19 | F | F |
| (Sheet KH-2-1) | | | | |
| Inventive Example 2-2 | 27 | 19 | G | G |
| (Sheet KH2-2) | | | | |
| Inventive Example 2-3 | 27 | 18 | E | E |
| (Sheet KH2-3) | | | | |
| Inventive Example 2-4 | 26 | 17 | EE | EE |
| (Sheet KH2-4) | | | | |
| Inventive Example 3-1 | 24 | 18 | E | E |
| (Sheet KH3-1) | | | | |
| Inventive Example 3-2 | 23 | 18 | EE | E |
| (Sheet KH3-2) | | | | |
| Inventive Example 3-3 | 23 | 17 | E | EE |
| (Sheet KH3-3) | | | | |
| Inventive Example 3-4 | 22 | 17 | EE | EE |
| (Sheet KH3-4) | | | | |
| Inventive Example 3-5 | 19 | 15 | EEE | EE |
| (Sheet KH3-5) | | | | |
| Inventive Example 3-6 | 21 | 16 | EE | EEE |
| (Sheet KH3-6) | | | | |
| Inventive Example 3-7 | 20 | 16 | EEE | EEE |
| (Sheet KH3-7) | | | | |

Evaluation level:
PP: Very poor;
F: Fair;
G: Good;
E < EE < EEE

As set forth in Table 1, the inventive examples can accomplish objects of the invention in respect to resistance both to drying unevenness and streak.

It will be apparent to those skilled in the art that various modifications and variations can be made to the described embodiments of the invention without departing from the spirit or scope of the invention. Thus, it is intended that the invention cover all modifications and variations of this invention consistent with the scope of the appended claims and their equivalents.

The present application claims foreign priority based on Japanese Patent Application No. JP2005-288411 filed Sep. 30 of 2005, the contents of which is incorporated herein by reference.

What is claimed is:

1. An optical film comprising:
a support; and
an optically anisotropic layer comprising a fluorine-containing polymer and a liquid crystal compound, the optically anisotropic layer having a CFn intensity ratio P of 10% to 25% at a photoelectron takeoff angle φ of 20° and a CFn intensity ration P of 15% to 20% at a photoelectron takeoff angle φ of 30°, wherein the CFn intensity ratio P and the photoelectron takeoff angle φ are obtained by AR-XPS measurement.

2. The optical film according to claim 1, wherein the fluorine-containing polymer is a copolymer.

3. The optical film according to claim 1, wherein the fluorine-containing polymer has a repeating unit derived from a hydrophilic monomer.

4. The optical film according to claim 1, further comprising an alignment layer between the support and the optically anisotropic layer.

5. The optical film according to claim 1, wherein the fluorine-containing polymer comprises a fluoroaliphatic group-containing copolymer, the fluoroaliphatic group-containing copolymer comprising: a repeating unit derived from monomer (i); and a repeating unit derived from monomer (ii):
(i) Fluoroaliphatic group-containing monomer represented by formula (1); and
(ii) At least one of poly(oxyalkylene)acrylate and poly (oxyalkylene)methacrylate:
Formula (1): 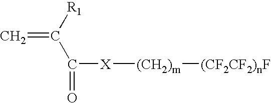
wherein R₁ represents a hydrogen atom or methyl group; X represents an oxygen atom, sulfur atom or —N(R₂)—, and R₂ represents a hydrogen atom or C₁-C₄ alkyl group; m represents an integer of 1 to 6; and n represents an integer of 2 to 4.

6. The optical film according to claim 5, wherein the fluoroaliphatic group-containing copolymer further comprises a repeating unit derived from monomer (iii) represented by formula (2), which is copolymerizable with the monomers (i) and (ii):
Formula (2): 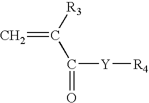
wherein R₃ represents a hydrogen atom or methyl group; Y represents a divalent connecting group; and R₄ represents a C₄-C₂₀ straight-chain, branched or cyclic alkyl group which may have substituents.

7. The optical film according to claim 1, wherein the liquid crystal compound is a discotic compound.

8. A method for producing an optical film of claim 4, comprising coating, on an alignment layer, a composition containing a fluorine-containing polymer and a liquid crystal to form an optically anisotropic layer.

9. A polarizing plate comprising an optical film according to claim 1.

10. A liquid crystal display comprising an optical film according to claim 1.
